(19) United States
(12) Patent Application Publication
(10) Pub. No.: US 2022/0400007 A1
(43) Pub. Date: Dec. 15, 2022

(54) ENCRYPTION KEY MANAGEMENT SYSTEM AND ENCRYPTION KEY MANAGEMENT METHOD

(71) Applicant: Hitachi, Ltd., Tokyo (JP)

(72) Inventors: Yutaka YOSHIDA, Tokyo (JP); Mioko MORIGUCHI, Tokyo (JP)

(21) Appl. No.: 17/692,249

(22) Filed: Mar. 11, 2022

(30) Foreign Application Priority Data
Jun. 9, 2021 (JP) 2021-096949

(51) Int. Cl. H04L 9/08

(52) U.S. Cl. CPC H04L 9/0894; H04L 9/0861

(57) ABSTRACT

A key management control unit of a storage device instructs a key management server to generate an encryption key, and receives the corresponding key number. The key management control unit requests the key management server to acquire the encryption key by the key number when newly assigning the encryption key to a drive of the storage device, and retains attribute information of the acquired encryption key, and the acquired encryption key as a reserved encryption key in a reserved encryption key area of a volatile area. Then, the key management control unit updates an encryption key management information table by applying a key tag to the reserved encryption key as the encryption key to be assigned to the drive of the storage device, and retains the reserved encryption key as a new encryption key corresponding to the drive of the storage device in an encryption key table.

### CROSS-REFERENCE TO RELATED APPLICATION

The present application claims priority from Japanese application JP 2021-096949, filed on Jun. 9, 2021, the contents of which is hereby incorporated by reference into this application.

### BACKGROUND OF THE INVENTION

### 1. Field of the Invention

The present invention relates to an encryption key management system and an encryption key management method, and in particular, relates to an encryption key management system and an encryption key management method preferable for reducing the amount of storage resource to be used for encryption and reducing maintenance time for maintaining security in a case of storing a key to be encrypted in the external server, in a storage device encrypting data.

### 2. Description of the Related Art

Recently, in order to improve data security, a storage device having an encryption function has been used. In such a storage device having an encryption function, data is encrypted by using an encryption key and stored in a memory device such as a hard disk drive (HDD). In this case, in a case where the encryption key is lost, encryption data is not capable of being decrypted, which is virtually equivalent to losing data.

On the other hand, it is not preferable to store the encryption key and the data encrypted by using the encryption key in the storage device from the viewpoint of the security. This is because when the entire storage device is stolen, the encrypted data is decrypted, and information may be leaked.

Therefore, for example, in U.S. Pat. No. 8,010,810, a technology is proposed in which an encryption key is stored in a key management server separately from a storage device, and the storage device acquires and uses the encryption key from the key management server when required.

The encryption key is assigned to each disk board including a drive and an encryption chip, and in a case of the replacement with a service part, the encryption key is updated such that data is not capable of being read by obtaining the key from the replaced part. In such a case, since it is possible to read the data from the drive only when the encryption key is the newest encryption key set, in a case where the encryption key is updated, it is necessary to store again the updated encryption key in the key management server and to constantly keep key information of the key management server up-to-date.

In U.S. Pat. No. 8,010,810 described above, the encryption key is assigned to each of the drives, and associated by uniquely identifying hardware in the storage device for each of the encryption keys and by retaining information for managing the encryption key in a non-volatile area.

In this case, since the encryption key is scrapped and an unused key is used in the replacement of the drive, in general, an encryption key is created in plenty of time. A security manager generates in advance an encryption key that is retained without being assigned to the drive (hereinafter, referred to as a “reserved encryption key”), and imports the encryption key into the storage device.

This is because in a case of retaining the minimum number of encryption keys to be assigned to the drive in the storage device without retaining the reserved encryption key in the storage device, it is necessary to generate the key every time when the drive is replaced, the number of times of generating the key increases, and the maintenance time increases.

However, in a case of operating a system by the reserved encryption key, it is necessary to retain the reserved encryption key in the storage device before the maintenance of the drive. Therefore, the following problems occur.
(1) It is necessary for the security manager to check the reserved encryption key for each storage to be managed and to generate in advance an encryption key according to a maintenance plan. Accordingly, the management cost of the security manager increases. In a case where the security manager makes a mistake in the plan, the reserved encryption key is used up during the maintenance of the drive.
(2) The encryption key to be actually used is only the encryption key assigned to the drive, and the reserved encryption key is not used unless the maintenance of the drive occurs. It is necessary to retain information of the reserved encryption key that is not used in the non-volatile area and a volatile area of the storage device, and an extra capacity resource of a storage of a client is used.
(3) Since the number of drive failures increases as the number of drives to be mounted on the storage device increases, the number of required reserved encryption keys increases in accordance with the scale-out of the number of drives. Accordingly, since a required management information area increases in accordance with the scale-out of the number of drives, in consideration of this, it is necessary to add the capacity resource of the storage of the client.

In addition, in a case of newly importing the encryption key to the storage device, it is necessary to back up the encryption key in the key management server in order to prevent the encryption key from being lost from the volatile area due to a blackout or the like. The decryption of the data is prevented from being unable due to the loss of the encryption key, and data writing with respect to the drive is unable until the backup is completed.

It is necessary to store a key number to be used as a query when acquiring the backup from the key management server (a number to be a key when the storage acquires the information of the encryption key from the key management server) in the storage device, which is managed once for each of the key management servers. Accordingly, only one backup can be performed with respect to the storage device, and the backup of the encryption key is constantly a full backup in the related art. In a case where the reserved encryption key is used up during the maintenance of the drive, it is necessary to newly generate, import, and back up the encryption key, but in a case where the backup of the encryption key is the full backup, it takes time for the backup, drive maintenance time increases, and drive degeneration (a state in which the redundancy of a logical drive is lost) time also increases. In general, it takes time for the backup in accordance with the number of drives, which makes the scale-out of the drive difficult in a backup method of the full backup of the encryption key, in the related art.

### SUMMARY OF THE INVENTION

An object of the invention is to provide an encryption key management system in which in a case where a key to be encrypted is stored in an external server, in a storage device encrypting data, the amount of storage resource to be used for the encryption can be reduced, and maintenance time for maintaining security can be reduced.

An encryption key management system of the invention is preferably configured as an encryption key management system including one or a plurality of drives assigned with different encryption keys, respectively, in which a storage device encrypting data the assigned encryption key to store the data in the corresponding drive and a key management server storing the encryption key and information relevant to the encryption key in a key management database are connected to each other through a network, in which the storage device includes a key management control unit managing the encryption key, a volatile area for memorizing data, and a non-volatile area, an encryption key table including the encryption key and information of the drive that is an assignment destination is retained in the volatile area, an encryption key management information table including attribute information relevant to the encryption key and a key tag that is unique in the storage device and associated with the encryption key is retained in the non-volatile area, the storage device performs reserved encryption key generation processing of instructing the key management server to generate the encryption key to be assigned to the drive, the storage device performs reserved encryption key assignment processing of acquiring the encryption key generated in the reserved encryption key generation processing from the key management server and of assigning the encryption key to the drive, in the reserved encryption key generation processing, the key management control unit instructs the key management server to generate the encryption key, the key management server generates the instructed encryption key, and stores a key number that is unique in the key management server and associated with the encryption key in the key management database and transmits the key number to the storage device, and in the reserved encryption key assignment processing, the key management control unit requests the key management server to acquire the encryption key on the basis of the key number, the key management server reads out an encryption key corresponding to the request for acquiring the encryption key and attribute information of the encryption key from the key management database, and transmits the encryption key and the attribute information to the key management control unit, and the key management control unit stores the acquired encryption key as a reserved encryption key along with the attribute information in a reserved encryption key area of the volatile area, applies the key tag to the reserved encryption key to be stored and updated along with the attribute information in the encryption key management information table, and stores the reserved encryption key as a new encryption key corresponding to the drive that is an assignment target along with the key tag in the encryption key table.

According to the invention, it is possible to provide an encryption key management system and an encryption key management method in which in a case where a key to be encrypted is stored in an external server, in a storage device encrypting data, the amount of storage resource to be used for the encryption can be reduced, and maintenance time for maintaining security can be reduced.

### BRIEF DESCRIPTION OF THE DRAWINGS

FIG. 1 is a block diagram illustrating the overall configuration of an encryption key management system;

FIG. 2 is a diagram illustrating an example of an encryption key management information table according to a first embodiment;

FIG. 3 is a diagram illustrating an example of a key management server connection setting table;

FIG. 4 is a diagram illustrating an example of a key management server information table;

FIG. 5A is a diagram illustrating an example of an encryption key table (primary node);

FIG. 5B is a diagram illustrating an example of an encryption key table (a worker node);

FIG. 6 is a diagram illustrating an example of a reserved encryption key area table;

FIG. 7 is a diagram illustrating an example of a key management table;

FIG. 8 is a diagram illustrating a set of processings until the primary node registers a reserved encryption key in a key management server, in the first embodiment;

FIG. 9 is a diagram illustrating a set of processings until the primary node acquires the reserved encryption key from the key management server to be used as an encryption key of data, in the first embodiment;

FIG. 10 is a UML sequence diagram illustrating the details of processing of generating the reserved encryption key;

FIG. 11 is a UML sequence diagram illustrating the details of processing of deleting the reserved encryption key;

FIG. 12 is a UML sequence diagram illustrating the details of processing of acquiring the number of unused encryption keys;

FIG. 13 is a UML sequence diagram illustrating the details of processing of acquiring the reserved encryption key;

FIG. 14 is a (first) UML sequence diagram illustrating the details of processing of assigning the reserved encryption key as the encryption key for encrypting the data;

FIG. 15 is a UML sequence diagram illustrating processing of replacing a drive;

FIG. 16 is a UML sequence diagram illustrating processing of replacing the node;

FIG. 17 is a diagram illustrating an example of an encryption key management information table according to a second embodiment;

FIG. 18A is a diagram illustrating an example of encryption key backup data (a full backup);

FIG. 18B is a diagram illustrating an example of encryption key backup data (an incremental backup);

FIG. 19 is a diagram illustrating an example of an incremental backup list;

FIG. 20 is a diagram illustrating a set of processings until the primary node performs the incremental backup with respect to the encryption key in the key management server, in the second embodiment;

FIG. 21 is a diagram illustrating a set of processings until the primary node restores the incremental backup from the key management server, in the second embodiment;

FIG. 22 is a (second) UML sequence diagram illustrating the details of the processing of assigning the reserved encryption key as the encryption key for encrypting the data;

FIG. 23 is a UML sequence diagram illustrating the details of processing of performing the incremental backup with respect to the encryption key;

FIG. 24 is a UML sequence diagram illustrating the details of processing of performing the full backup with respect to the encryption key;

FIG. 25 is a UML sequence diagram illustrating the details of processing of restoring the encryption key; and

FIG. 26 is a UML sequence diagram illustrating the details of processing of restoring the incremental backup of the encryption key.

### DETAILED DESCRIPTION OF THE PREFERRED EMBODIMENTS

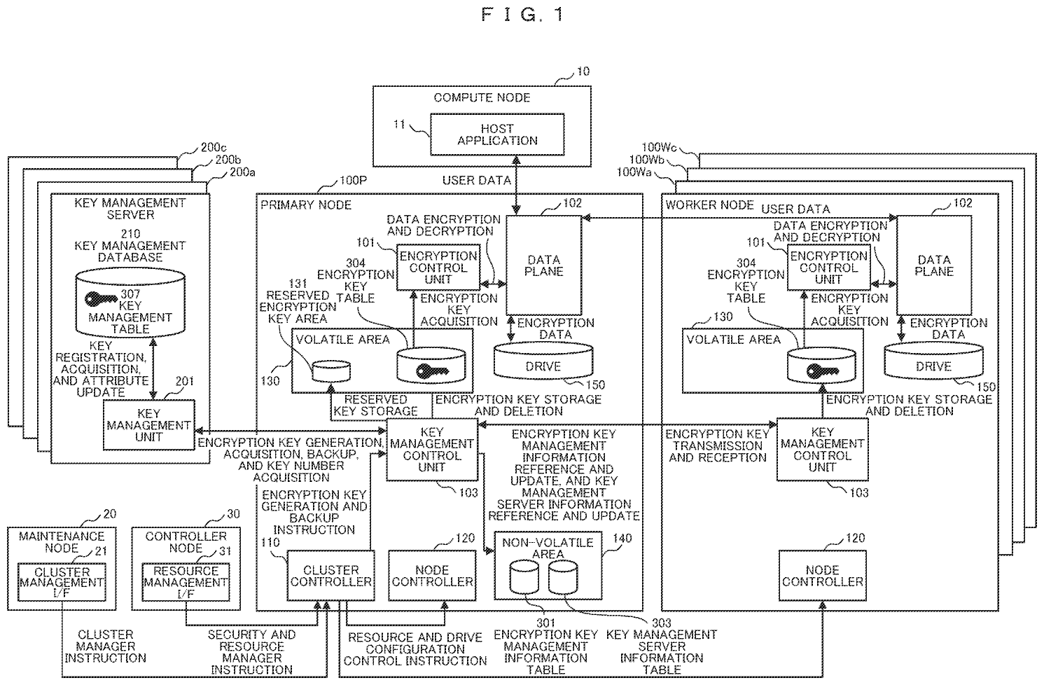

Hereinafter, each embodiment according to the invention will be described by using FIG. 1 to FIG. 26.

### First Embodiment

Hereinafter, a first embodiment according to the invention will be described by using FIG. 1 to FIG. 16.

First, the configuration of an encryption key management system according to the first embodiment will be described by using FIG. 1.

In this embodiment, an example of an encryption key management system in which software defined storage (SDS) is applied as a storage system will be described. SDS is a virtual storage system that can be attained as a hardware resource, without including a specific storage device.

As illustrated in FIG. 1, the encryption key management system of this embodiment includes a compute node 10, a maintenance node 20, a controller node 30, a primary node 100P, a worker node 100W (in the drawing, represented by 100Wa, 100Wb, . . . ), and a key management server (in the drawing, represented by 200a, 200b, . . . ) 200.

Note that, the controller node 30 and the primary node 100P will be collectively referred to as a cluster in the following description.

The compute node 10 is a function node that executes a host application 11. The maintenance node 20 is a function node that is connected to the primary node 100P through a cluster management I/F 21 and performs the maintenance of the cluster. The controller node 30 is a function node that is connected to the primary node 100P through a resource management I/F 31 and performs the control of the cluster. The primary node 100P is a function node that performs the control of the own drive as a storage node and the control of all of the connected subordinate worker nodes 100W.

The key management server 200 is a server that generates and acquires an encryption key, and transmits a backup key number, in accordance with a request from the primary node 100P. The key management server 200 includes a key management unit 201, accesses a key management database 210, and performs access and management with respect to information relevant to the encryption key. Note that, the type of table to be included in the key management database 210 will be described below in detail.

The primary node 100P is a node having a function of controlling all of the nodes in the cluster, and includes an encryption control unit 101, a data plane 102, a key management control unit 103, a cluster controller 110, a node controller 120, a volatile area 130, a non-volatile area 140, and a drive 150.

The encryption control unit 101 is a function unit that acquires an encryption key stored in the volatile area 130 and encrypts plaintext data in the in the cluster. The data plane 102 is a function unit that transfers user data and encryption data between the compute node 10 and the drive in the cluster. The key management control unit 103 has a function of managing the encryption key, of referring to and updating the information relevant to the encryption key, and of referring to and updating information relevant to the key management server 200. The key management control unit 103 stores and deletes the encryption key in the volatile area 130 (an encryption key table), stores and deletes the information relevant to the encryption key in the non-volatile area 140 (an encryption key management information table), and refers to and updates the information relevant to the key management server 200 (a key management server information table). In addition, the key management control unit 103 stores a reserved encryption key in a reserved encryption key area 131 of the volatile area 130. The cluster controller 110 is a function unit that receives an instruction of a cluster manager from the maintenance node 20 and an instruction of a security resource manager from the controller node 30, and instructs the key management control unit 103 to generate and back up the encryption key. In addition, the cluster controller 110 is connected to the own node controller 120 and another worker node 100W, and instructs the control of the resource and drive configuration. The node controller 120 is a function unit that is connected to the cluster controller 110 and receives the instruction of the control of the resource and drive configuration.

The worker node 100W is a node that is controlled by the primary node 100P and has a function as a storage, and includes the encryption control unit 101, the data plane 102, the key management control unit 103, the node controller 120, the volatile area 130, and the drive 150. The main function is the same as the function of the primary node 100P.

In the primary node 100P and the worker node 100W, the volatile area 130, for example, may include DRAM that is a volatile memory device, and the non-volatile area 140 and the drive 150, for example, may include a solid state drive (SSD) or a hard disk drive (HDD) that is a non-volatile memory device.

The data plane 102 of the worker node 100W transfers the user data with respect to the data plane 102 of the primary node 100P, and stores or reads out the encryption data in the drive 150.

The key management control unit 103 of the worker node 100W receives the encryption key from the key management control unit 103 of the primary node 100P, and stores the encryption key in the volatile area 130 (the encryption key table).

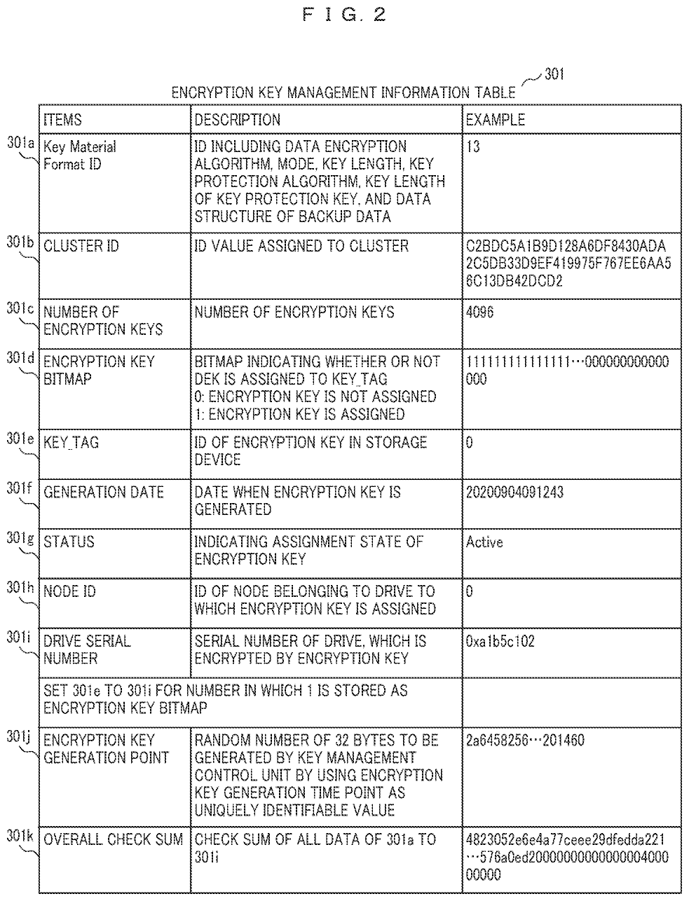

Next, a data structure that is used in the encryption key management system of the first embodiment will be described by using FIG. 2 to FIG. 7.

An encryption key management information table 301 is a table for managing the information relevant to the encryption key in the cluster of the storage, and is stored in the non-volatile area 140 of the primary node 100P. As illustrated in FIG. 2, the encryption key management information table 301 includes setting items of a key material format ID 301a, a cluster ID 301b, a number 301c of encryption keys, an encryption key bitmap 301d, a KEY_TAG 301e, a generation date 301f, a status 301g, a node ID 301h, a drive serial number 301i, an encryption key generation point 301j, and an overall check sum 301k.

The key material format ID 301a is an ID including a data encryption algorithm, a mode, a key length, a key protection algorithm, a key length of a key protection key, and a data structure of backup data. The cluster ID 301b is an ID value assigned to the cluster. The number 301c of encryption keys is the number of encryption keys. The encryption key bitmap 301d is a bitmap indicating whether or not the encryption key is assigned to KEY_TAG (the next item), and the value indicates that “0: the encryption key is not assigned” and “1: the encryption key is assigned”. The KEY_TAG 301e is the ID of the encryption key in the storage device. The generation date 301f is a date when the encryption key is generated. The status 301g is an assignment state (Active and NonActive) of the encryption key. The node ID 301h is the ID of a node belonging to the drive to which the encryption key is assigned. The drive serial number 301i is the serial number of the drive, which is encrypted by the encryption key. The encryption key generation point 301j is a random number of 32 bytes to be generated by the key management control unit 103 by using an encryption key generation time point as a uniquely identifiable value. The value is used for controlling the backup and the recovery of the encryption key. The overall check sum 301k is the check sum of the values of the key material format ID 301a, the cluster ID 301b, the number 301c of encryption keys, the encryption key bitmap 301d, the KEY_TAG 301e, the generation date 301f, the status 301g, the node ID 301h, and the drive serial number 301i.

Note that, the items of the KEY_TAG 301e, the generation date 301f, the status 301g, the node ID 301h, the drive serial number 301i are set for the number in which the value of the encryption key bitmap 301d is “1”.

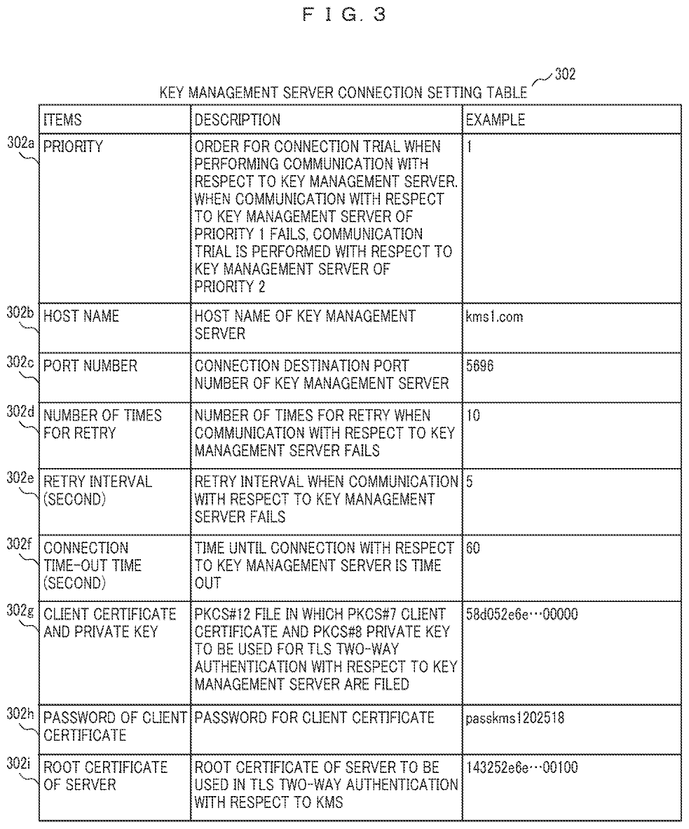

A key management server connection setting table 302 is a table for the primary node 100P of the cluster and the key management server 200 to be connected through a network, and is stored in the non-volatile area 140 of the primary node 100P. As illustrated in FIG. 3, the key management server connection setting table includes setting items of a priority 302a, a host name 302b, a port number 302c, a number 302d of times for retry, a retry interval [second] 302e, a connection time-out time [second] 302f, a client certificate and a private key 302g, a password 302h of the client certificate, and a root certificate 302i of the server.

The priority 302a is an order for a connection trial when performing communication with respect to the key management server 200. The host name 302b is a host name of the key management server. The port number 302c is a connection destination port number of the key management server. The number 302d of times for retry is the number of times for retry in a case where the communication with respect to the key management server fails. The retry interval [second] 302e is a second-scale retry interval in a case where the communication with respect to the key management server fails. The connection time-out time [second] 302f is second-scale time until the connection with respect to the key management server is time out. The client certificate and the private key 302g is a PKCS #12 file in which a PKCS #7 client certificate and a PKCS #8 private key to be used for transport layer secret security (TLS) two-way authentication with respect to the key management server are filed. The password 302h of the client certificate is a password for the client certificate. The root certificate 302i of the server is a root certificate of the server to be used in the TLS two-way authentication with respect to the key management service (KMS).

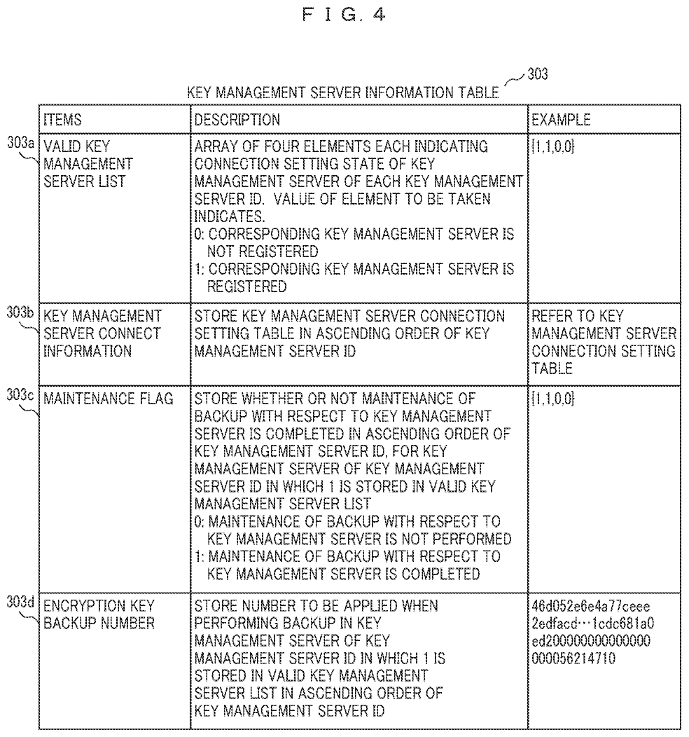

A key management server information table 303 is a table for the primary node 100P of the cluster to store the information relevant to the key management server 200, and is stored in the non-volatile area 140 of the primary node 100P. As illustrated in FIG. 4, the key management server information table 303 includes setting items of a valid key management server list 303a, a key management server connect information 303b, a maintenance flag 303c, and an encryption key backup number 303d. The valid key management server list 303a is an array of flags of the number n of elements (n is an integer of 1 or more) each indicating a connection setting state of the key management server of each key management server ID. The value of the element to be taken indicates “0: the corresponding key management server is not registered” and “1: the corresponding key management server is registered”. The key management server connect information 303b is a pointer to the key management server connection setting table 302 stored in ascending order of the key management server ID. The maintenance flag 303c is an array of flags in which a flag indicating whether or not the information relevant to the encryption key of 130 stored in the volatile area is registered and maintained in the key management server is stored in ascending order of the key management server ID. The value of the element to be taken indicates “0: the information relevant to the encryption key is not maintained in the key management server” and “1: the information relevant to the encryption key is maintained in the key management server”.

The encryption key backup number 303d is a string of numbers in which a number to be applied when performing the backup in the key management server 200 of the key management server ID in which 1 is stored in the valid key management server list is stored in ascending order of the key management server ID.

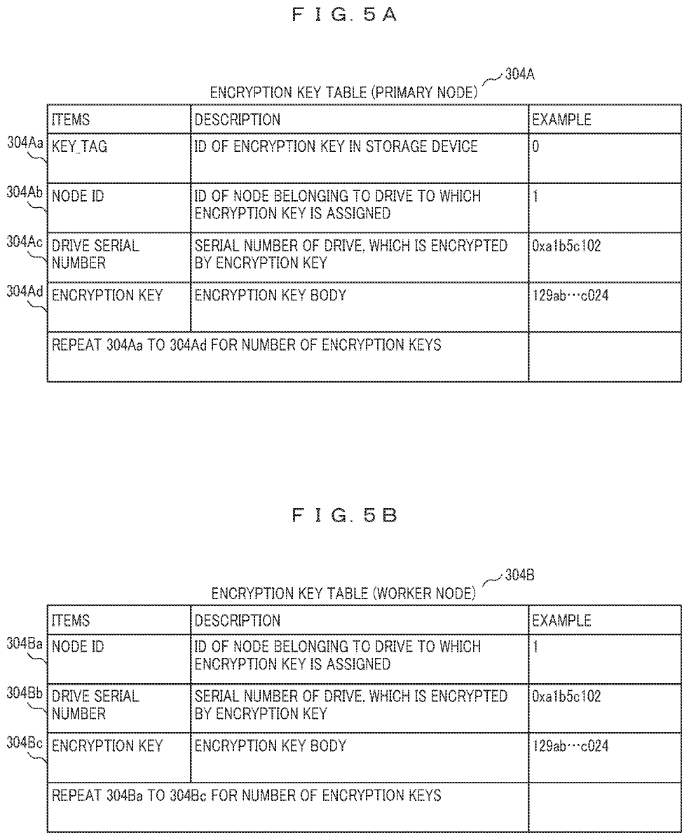

An encryption key table (primary node) 304A is a table for retaining the information relevant to the encryption key for encrypting data to be retained in the primary node 100P of the cluster, and is retained in the volatile area 130 of the primary node 100P. As illustrated in FIG. 5A, the encryption key table (primary node) 304A includes setting items of a KEY_TAG 304Aa, a node ID 304Ab, a drive serial number 304Ac, and an encryption key 304Ad. The KEY_TAG 304Aa is the ID of the encryption key in the storage device. The node ID 304Ab is the ID of the node belonging to the drive to which the encryption key is assigned. The drive serial number 304Ac is a serial number of the drive, which is encrypted by the encryption key. The encryption key 304Ad is an encryption key body.

Note that, the items of the KEY_TAG 304Aa, the node ID 304Ab, the drive serial number 304Ac, and the encryption key 304Ad are repeatedly set for the number of encryption keys to be retained in the primary node 100P.

An encryption key table (worker node) 304B is a table for retaining the information relevant to the encryption key for encrypting the data to be retained in the worker node 100W of the cluster, and is retained in the volatile area 130 of the worker node 100W. As illustrated in FIG. 5B, the encryption key table (worker node) 304B includes setting items of a KEY_TAG 304Ba, a node ID 304Bb, a drive serial number 304Bc, and an encryption key 304Bd. The meaning of each of the items is the same as the encryption key table (primary node) 304A illustrated in FIG. 5A.

Note that, the encryption key table (primary node) 304A retains the information of the encryption key of all of the nodes in the cluster, and the encryption key table (worker node) 304B retains only the information of the encryption key relevant to the own worker node 100W.

In this embodiment, the encryption key tables 304A and 304B may be constructed by acquiring information required for the key management control unit 103 of each of the nodes from the key management server 200 every time when the primary node 100P and the worker node 100W are restarted, respectively.

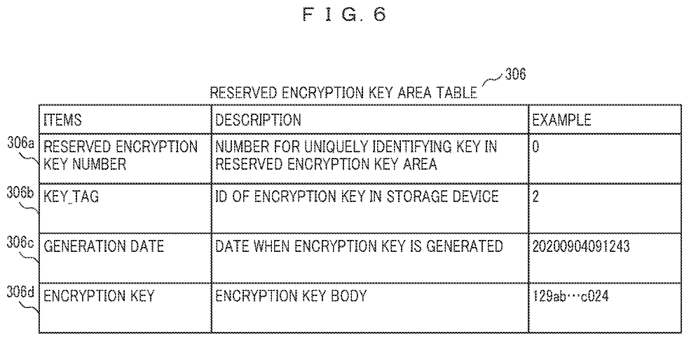

A reserved encryption key area table 306 is a table for retaining information relevant to the reserved encryption key to be stored in the reserved encryption key area 131, and is retained in the volatile area 130 of the primary node 100P of the cluster. As illustrated in FIG. 6, the reserved encryption key area table 306 includes setting items of a reserved encryption key number 306a, a KEY_TAG 306b, a generation date 306c, and an encryption key 306d. The reserved encryption key number 306a is a number for uniquely identifying a key in the reserved encryption key area 131. The KEY_TAG 306b is the ID of the encryption key in the storage device. The generation date 306c is a date when the encryption key is generated. The encryption key 306d is an encryption key body.

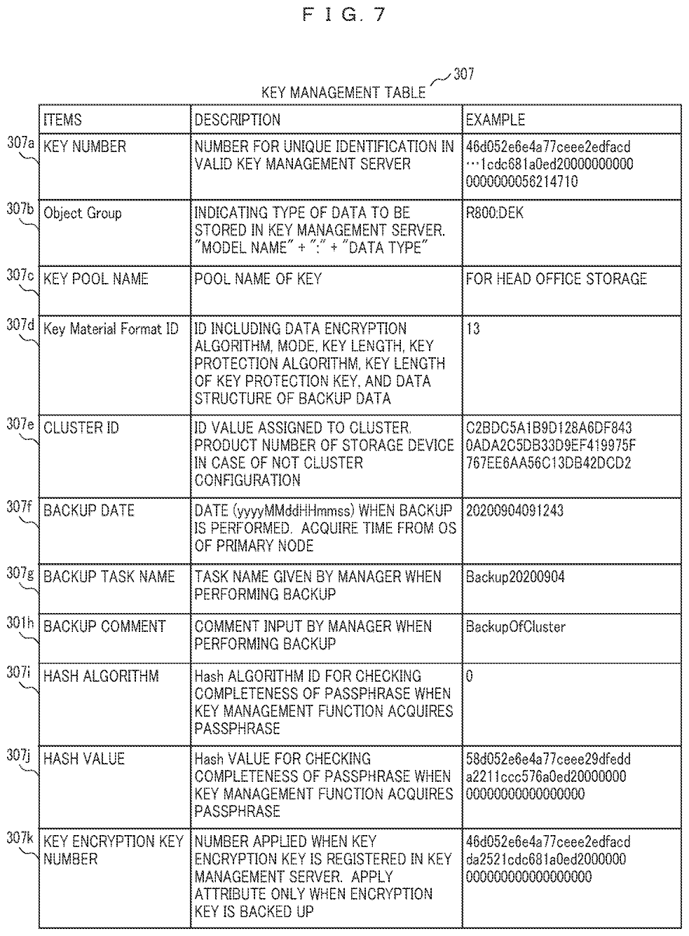

A key management table 307 is a table for managing the information of the encryption key, and is retained in the key management database 210 of the key management server 200. As illustrated in FIG. 7, the key management table 307 includes setting items of a key number 307a, an Object Group 307b, a key pool name 307c, a key material format ID 307d, a cluster ID 307e, a backup date 307f, a backup task name 307g, a backup comment 307h, a hash algorithm 307i, a hash value 307j, and a maintenance key encryption key number 307k.

The key number 307a is a number for uniquely identifying an encryption key in a valid key management server. Note that, even though it is not illustrated, an encryption key body corresponding to the key number 307a is associated with the value of the key number 307a, and is retained as another table of the key management database. The primary node of the cluster retains the key number, and queries about the information relevant to the encryption key to the key management server 200. The Object Group 307b is a character string indicating the type of data to be stored in the key management server. For example, “Model Name” “Encryption Key Type” is created. The key pool name 300c is the pool name of the key. The key material format ID 307d is an ID including a data encryption algorithm, a mode, a key length, a key protection algorithm, a key length of a key protection key, and a data structure of backup data. The cluster ID 307e is an ID value assigned to the cluster. In a case of not a cluster configuration, for example, the cluster ID is a product number of the storage device. The backup date 307f is capable of setting a time acquired from an operating system (OS) of the primary node, which is a date (yyyyMMddHHmmss) when the backup is performed. The backup task name 307g is a task name given by the manager when performing the backup. The backup comment 307h is a comment input by the manager when performing the backup. The hash algorithm 307i is a Hash algorithm ID for checking the completeness of a passphrase when a key management function acquires the passphrase. The hash value 307j is a Hash value for checking the completeness of the passphrase when the key management function acquires the passphrase. The maintenance key encryption key number 307k is the number of a key encryption key used when backing up the encryption key. This attribute is applied only when the encryption key is backed up and maintained in the key management server 200.

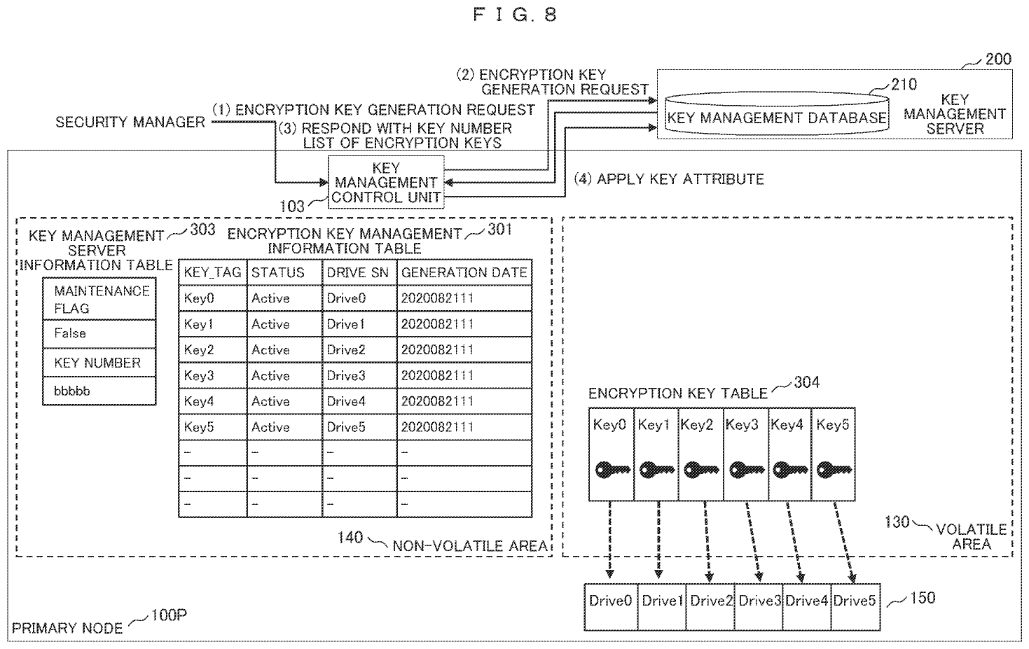

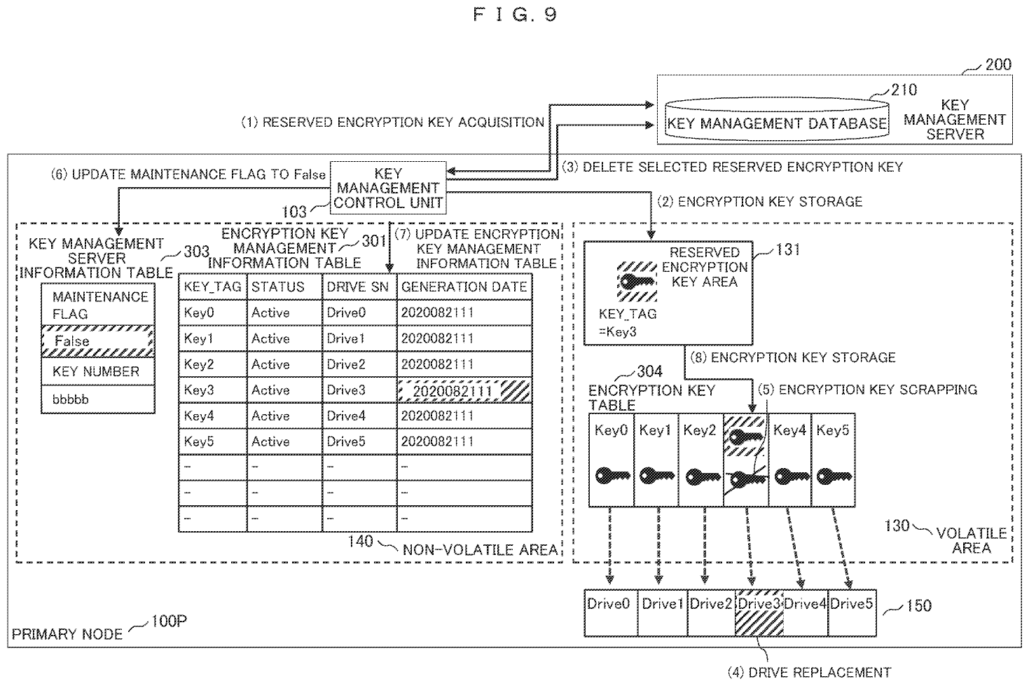

Next, the outline of an algorithm of the first embodiment will be described by using FIG. 8 and FIG. 9.

First, a set of processings until the primary node registers the reserved encryption key in the key management server will be described by using FIG. 8.

In the encryption key management system of this embodiment, the reserved encryption key is managed by the key management server, and acquired as necessary during the maintenance. In addition, by using the reserved encryption key over a plurality of storages, it is not necessary to perform management in storage unit.
(1) The security manager requests the key management control unit 103 of the primary node 100P to generate the reserved encryption key. In this case, the number of reserved encryption keys to be generated is designated.
(2) The key management control unit 103 requests the key management server 200 to generate the reserved encryption key.
(3) The key management server 200 responds with the key number of the encryption key for the number of reserved encryption keys to be generated. Hereinafter, the key number is a key when the primary node 100P acquires the encryption key from the key management server 200 or accesses the attribute.
(4) The key management control unit 103 requests the key management server to designate the key number and to apply the following attribute. According to such attribute application processing, it is possible to manage the encryption key with a plurality of nodes as a target in the key management server.
   Object Group: an identifier indicating the reserved encryption key, such as “DEK_Reserved”
   Cluster ID: a case of SDS, and may be a storage production number in a case of a block storage product.
   Reserved Encryption Key Pool Name: the security manager designates an arbitrary name.

In a case of deleting the reserved encryption key of the key management database, the key management server is searched by the following query, and the reserved encryption key is deleted by using the acquired key number. Accordingly, it is possible to delete the reserved encryption key from the storage in which the reserved encryption key is created.
Object Group=“DEK_Reserved”
Cluster ID
Reserved Encryption Key Pool Name=arbitrary

In addition, the security manager queries the key management server by the following query, and checks the number of key numbers for the response, and thus, it is possible to refer to the number of remaining reserved encryption keys.
Object Group=“DEK_Reserved”
Reserved Encryption Key Pool Name=arbitrary

Next, a set of processings until the primary node acquires the reserved encryption key from the key management server to be used as the encryption key of the data will be described by using FIG. 9.
(1) The key numbers of one or more encryption keys are acquired from the key management server 200 by using the following query.
   Object Group=“DEK_Reserved”
   Reserved Encryption Key Pool Name=arbitrary
(2) One is selected from the acquired key numbers, the key management server 200 is queried, and the encryption key and encryption key attribute information are stored in the reserved encryption key area 131 of the volatile area.
(3) The selected key number of the encryption key is designated, and the encryption key is deleted from the key management server 200. In a case where the deletion fails, since there is a possibility that the encryption key is used in the other storage, the encryption key ensured in the reserved encryption key area is deleted, the process returns to (2), and another encryption key is selected.
(4) A maintenance personnel of the system replaces the drive.
(5) The encryption key assigned to the drive is scrapped.
(6) The maintenance flag is updated to False.
(7) An attribute value such as a generation date of an encryption key that is newly stored in the reserved encryption key area 131 is input and updated in the portion of the KEY_TAG of the scrapped encryption key in the encryption key management information table 301.
(8) The encryption key stored in the reserved encryption key area 131 is stored in a portion where the encryption key is scrapped in the encryption key table. In such a case, KEY_TAG for identifying the key in which the encryption key is stored is stored in the reserved encryption key area.
(9) The encryption key is backed up in the key management server by the existing processing method. After the backup is completed, the maintenance flag is updated to True.

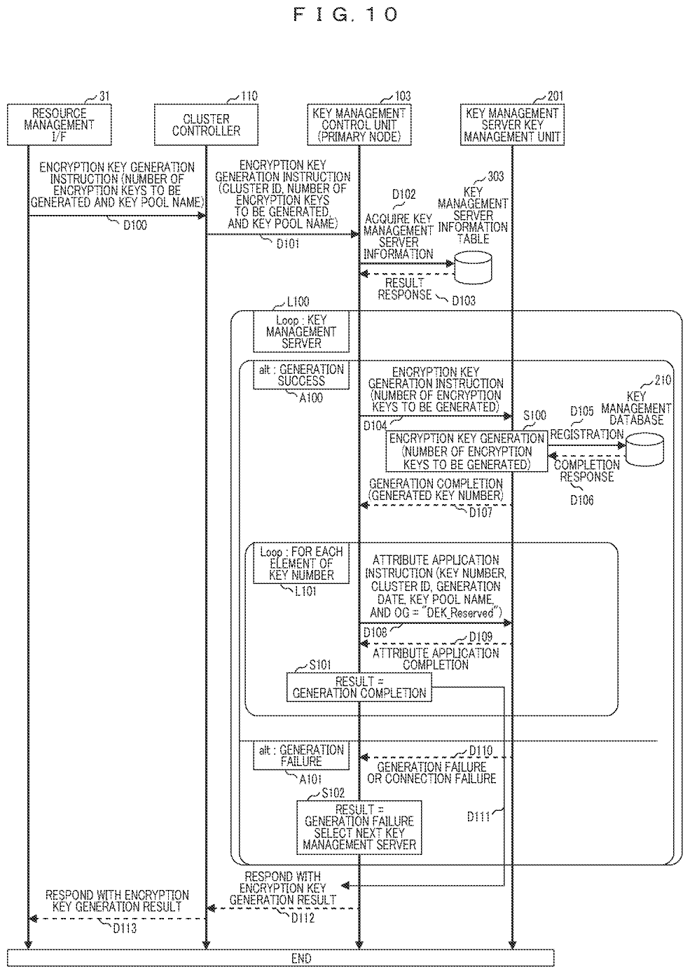

Next, the details of the processing of the encryption key management system of the first embodiment will be described by using FIG. 10 to FIG. 16.

First, the details of processing of generating the encryption key will be described by using FIG. 10.

The resource management I/F 31 of the controller node 30 instructs the cluster controller 110 of the primary node 100P to designate the number of encryption keys to be generated and the key pool name and to generate the encryption key (D100).

The cluster controller 110 designates the cluster ID, the number of encryption keys to be generated, and the key pool name, and instructs the key management control unit 103 of the primary node 100P to generate the encryption key (D101).

The key management control unit 103 of the primary node 100P acquires key management server information from the key management server information table 303 (D102 and D103).

Hereinafter, only for the key management server 200, the processing of A100 is performed when the generation of the encryption key succeeds, and the loop processing of the processing of A101 is performed when the generation of the encryption key fails (L100).

When the generation of the encryption key succeeds (A100), the processing of D104, D105, S100, and L101 is performed.

The key management control unit 103 instructs the key management unit 201 to designate the number of encryption keys to be generated and to generate the encryption key (D104).

The key management unit 201 generates the encryption key for the number of encryption keys to be generated (S100), registers the encryption key in the key management database 210 (D105), and waits for a completion response (D106).

The key management unit 201 transmits the key number for the number of encryption keys to be generated, and notifies the completion of the generation (D107).

Next, the processing of D108, D109, and S101 is performed for the number of elements of the key number for the number of encryption keys to be generated (L101).

The key management control unit 103 instructs the key management unit 201 to designate the key number, the cluster ID, the generation date, the key pool name, and ObjectGroup (in the drawing, abbreviated to “OG”)=“DEK_Reserved” and to perform an attribute application instruction (D108), and waits for attribute application completion (D109).

In a case where the generation of the encryption key is completed (S101), and the process exits from L101, the key management control unit 103 responds to the cluster controller 110 with an encryption key generation result (D112), and the cluster controller 110 responds to the resource management I/F 31 with the encryption key generation result (D113).

When the generation of the encryption key fails, the key management unit 201 notifies the key management control unit 103 that the generation fails or the connection fails (D110), and the key management control unit 103 selects the next key management server 200 as Result=Generation Fails (S102).

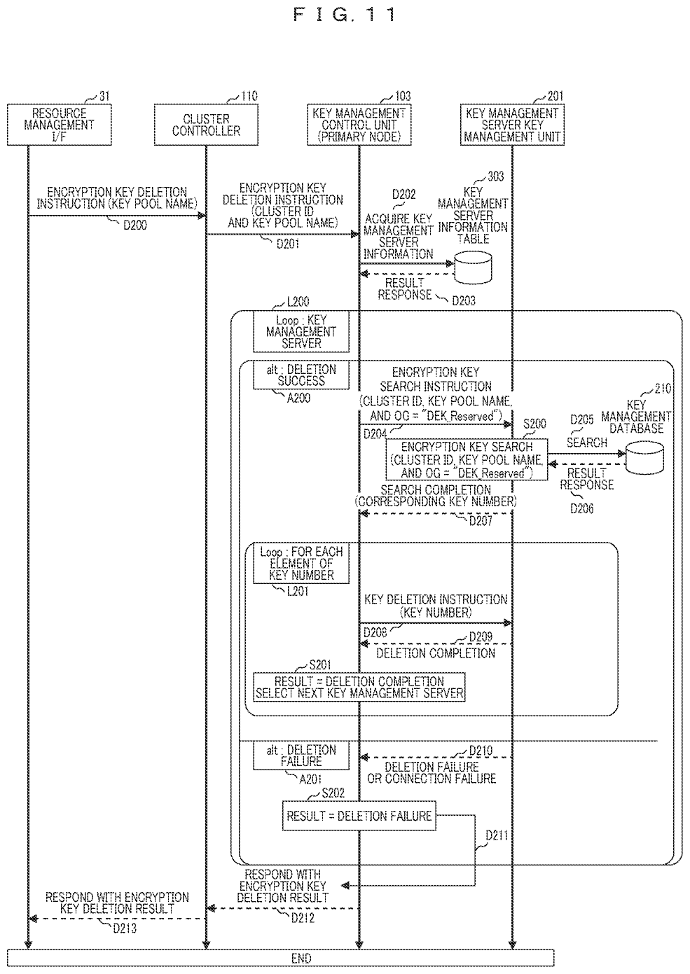

Next, the details of processing of deleting the encryption key will be described by using FIG. 11.

The resource management I/F 31 of the controller node 30 instructs the cluster controller 110 of the primary node 100P to designate the key pool name and to delete the encryption key (D200).

The cluster controller 110 designates the cluster ID and the key pool name, and instructs the key management control unit 103 of the primary node 100P to delete the encryption key (D201).

The key management control unit 103 of the primary node 100P acquires the key management server information from the key management server information table 303 (D202 and D203).

Hereinafter, only for the key management server 200, the processing of A200 is performed when the deletion of the encryption key succeeds, and the loop processing of A201 is performed when the deletion of the encryption key fails (L200).

When the deletion of the encryption key succeeds (A200), the loop processing of D204 to D207, S200, and L201 is performed.

The key management control unit 103 instructs the key management unit 201 to designate the cluster ID, the key pool name, and ObjectGroup=“DEK_Reserved”, and searches the encryption key (D204).

The key management unit 201 performs the search of the encryption key with respect to the cluster ID, the key pool name, and ObjectGroup=“DEK_Reserved” (S200), searches the key management database 210 (D205), and waits for a result response (D206).

The key management unit 201 transmits the corresponding number of key numbers to the key management control unit 103, and notifies the completion of the search (D207).

Next, the processing of D208, D209, and S201 is performed for the number of elements of the key number (L201).

The key management control unit 103 instructs the key management unit 201 to designate the key number and to delete the key (D208), and waits for the completion of the deletion (D209).

In a case where the deletion of the encryption key is completed, the next encryption key is selected (S201).

When the deletion of the encryption key fails, the key management unit 201 notifies the key management control unit 103 that the deletion fails or the connection fails (D210), the key management control unit 103 responds to the cluster controller 110 with an encryption key deletion result (D211) as Result=Deletion Fails (S202), and the cluster controller 110 responds to the resource management I/F 31 with the encryption key deletion result (D212).

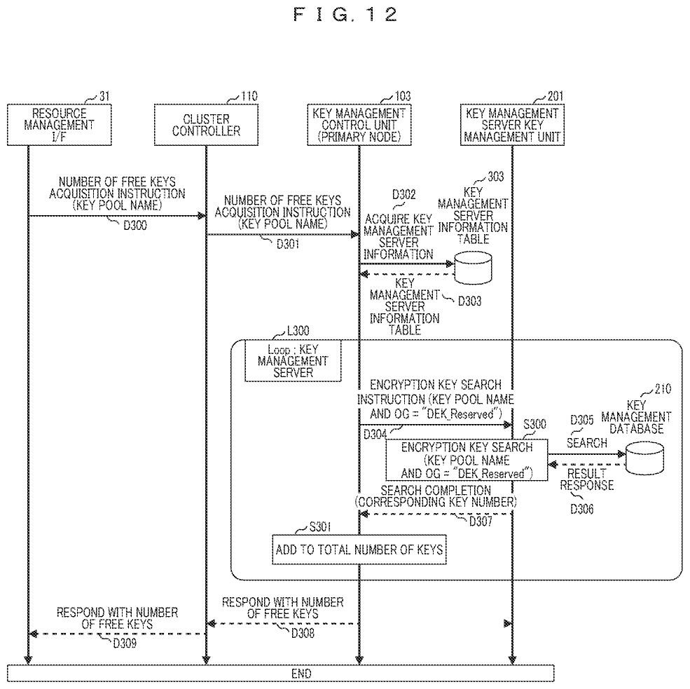

Next, the details of processing of acquiring the number of unused encryption keys will be described by using FIG. 12.

The resource management I/F 31 of the controller node 30 instructs the cluster controller 110 of the primary node 100P to designate the key pool name and to acquire the number of unused encryption keys (D300). The number of unused encryption keys is the number of encryption keys that can be used as the reserved encryption key.

The cluster controller 110 designates the key pool name, and instructs the primary node 100P to acquire the number of encryption keys (D301).

The key management control unit 103 of the primary node 100P acquires the key management server information from the key management server information table 303 (D302 and D303).

Hereinafter, only for the key management server 200, the loop processing of the processing of D304 to D307, S300, and S301 is performed (L300).

The key management control unit 103 instructs the key management unit 201 to designate the key pool name and ObjectGroup=“DEK_Reserved” and to search the encryption key (D304).

The key management unit 201 performs the search of the encryption key with respect to the key pool name and ObjectGroup=“DEK_Reserved” (S300), searches the key management database 210 (D305), and waits for a result response (D306).

The key management unit 201 transmits the corresponding number of key numbers to the key management control unit 103, and notifies the completion of the search (D307).

Next, the key management control unit 103 adds the number of elements of the key number to the total number of keys (S301).

In a case where the process exits from the loop L300, the key management control unit 103 responds to the cluster controller 110 with the number of unused encryption keys (D308), and the cluster controller 110 responds to the resource management I/F 31 with the number of unused encryption keys (D309).

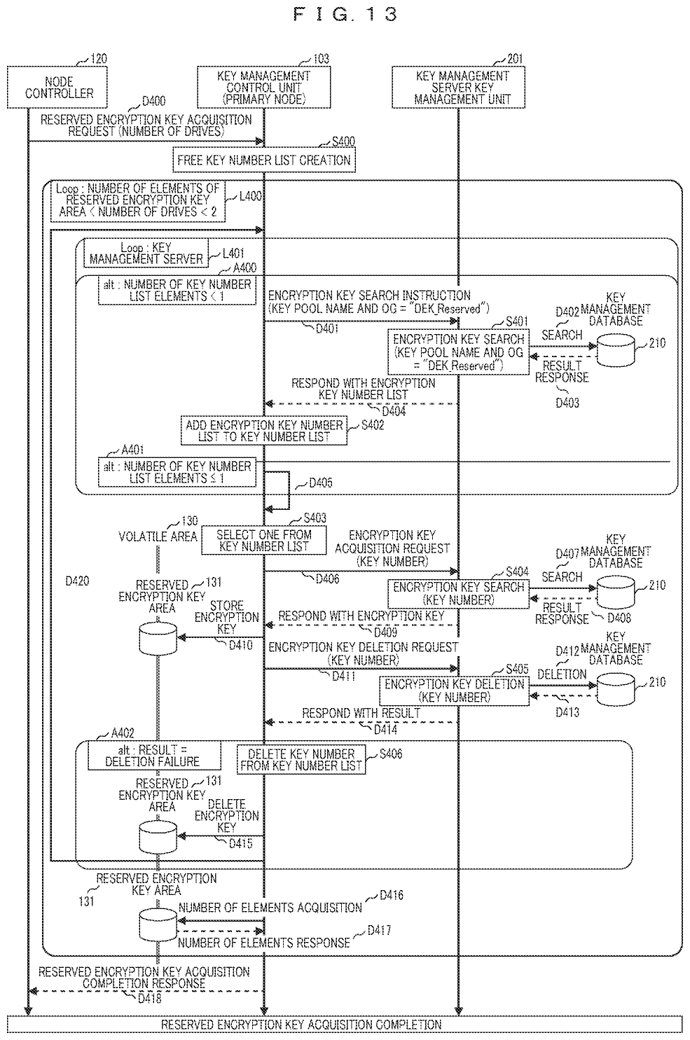

Next, the details of processing of acquiring the reserved encryption key will be described by using FIG. 13.

The node controller 120 of the primary node 100P designates the number of drives, and requests the key management control unit 103 of the primary node 100P to acquire the reserved encryption key (D400).

Note that, even though it is not illustrated, in a case where the node controller 120 of the worker node 100W designates the number of drives, and requests the key management control unit 103 of the worker node 100W to acquire the reserved encryption key, the key management control unit 103 of the worker node 100W delegates the processing to the key management control unit 103 of the primary node 100P.

The key management control unit 103 creates a free key number list (S400).

Next, when Number of Elements in Reserved Encryption Key Area<Number of Drives×2, the processing of L401, D406 to D418, and S403 to S406 is looped. Here, Number of Drives×2 is set since the key management control unit 103 of the primary node 100P also retains the information of the worker node 100W along with the primary node 100P.

Hereinafter, only for the key management server 200, the processing of A400 is performed when Encryption Key List<1, and the loop processing of the processing of A401 is performed when Encryption Key List≥1 (L400).

When Encryption Key List<1 (A400), the processing of D401 to D404, S401, and S402 is performed.

The key management control unit 103 instructs the key management unit 201 to designate the key pool name and ObjectGroup=“DEK_Reserved” and to search the encryption key (D401).

The key management unit 201 performs the search of the encryption key with respect to the key pool name and ObjectGroup=“DEK_Reserved” (S401), searches the key management database 210 (D402), and waits for a result response (D403).

The key management unit 201 transmits the corresponding number of key numbers to the key management control unit 103, and notifies the completion of the search (D404).

The key management control unit 103 adds the corresponding number of key numbers to the key number list (S402).

When Encryption Key List≥1, the process exits from the processing of L401, and the key management control unit 103 requests the key management unit 201 to select one key number (S403), to designate the key number, and to acquire the encryption key (D406).

The key management unit 201 performs the search of the encryption key with respect to the key number (S404), searches the key management database 210 (D407), and waits for a result response (D408).

The key management unit 201 responds with an encryption key corresponding to the key management control unit 103 (D409), and the key management control unit 103 stores the encryption key and the attribute information applied in the encryption key generation processing (refer to D108 in FIG. 10) in the reserved encryption key area 131 (D410).

The key management control unit 103 requests the key management unit 201 to designate the key number and to delete the encryption key of the key management unit 201 (D412).

The key management unit 201 performs the deletion of the encryption key (S405), requests the key management database 210 to delete the encryption key (D412), and waits for a result response (D413).

The key management unit 201 responds to the key management control unit 103 with a deletion request (D414).

When the deletion fails as a result, the key number is deleted from the key number list (S406), the encryption key of the reserved encryption key area 131 is deleted (D415), and the process returns to the loop of L401 (D420).

This is because the failure of the deletion request for the key management control unit 103 indicates that the encryption key is being used in the other storage, and thus, the encryption key is not capable of being used.

When the process exits from the loop of L401, the key management control unit 103 acquires the number of elements from the reserved encryption key area (D416 and D417), and notifies the node controller 120 that the acquisition of the reserved encryption key ends (D418).

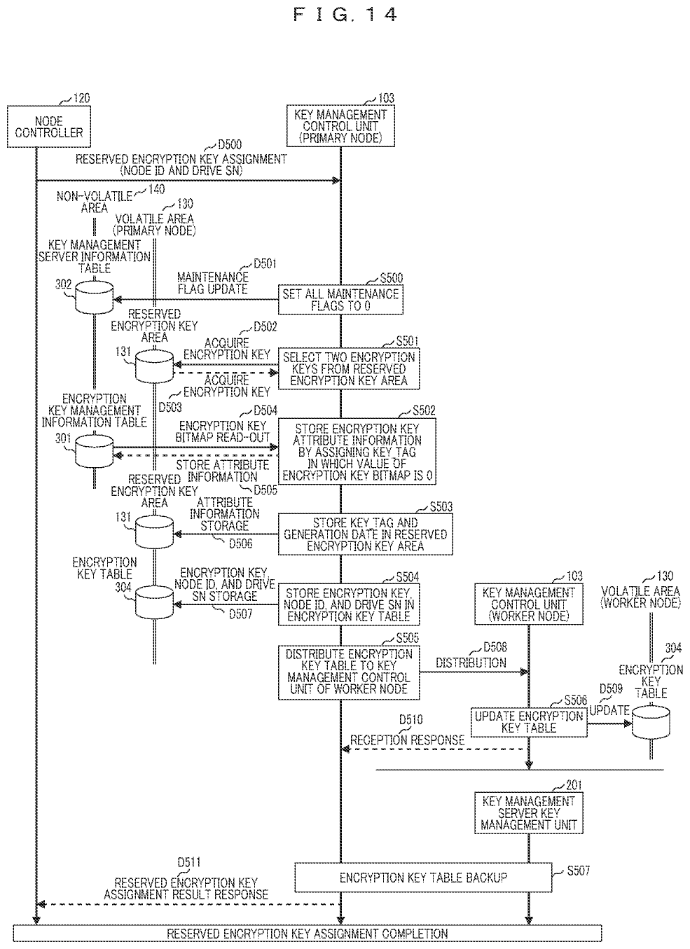

Next, the details of processing of assigning the reserved encryption key as the encryption key for encrypting the data will be described by using FIG. 14.

The node controller 120 of the primary node 100P requests the key management control unit 103 of the primary node 100P to designate the node ID and the drive serial number (in the drawing, noted as a “drive SN”), and to assign a reserved key (D500).

The key management control unit 103 sets the maintenance flag of the key management server information table 303 to 0 (S500), and updates the key management server information table 302 (D501).

The key management control unit 103 acquires the encryption key from the reserved encryption key area 131 (D502 and D503), and selects two encryption keys (S501). Two encryption keys are selected to be distributed to the own node and the worker node 100W.

The key management control unit 103 reads out the encryption key bitmap from the encryption key management information table 301 (D504), assigns KEY_TAG in which the value of the encryption key bitmap is 0, and stores the encryption key attribute information in the encryption key management information table 301 (S502 and D505).

The key management control unit 103 stores KEY_TAG and the generation date in the reserved encryption key area 131 (S503 and D506).

The key management control unit 103 stores the encryption key, the node ID, and the drive serial number in the encryption key table 304 (S504 and D507).

The key management control unit 103 of the primary node 100P distributes the encryption key table to the key management control unit 103 of the worker node 100W (S505 and D508).

The key management control unit 103 of the worker node 100W updates the encryption key table 304 (S506 and D509), and responds to the key management control unit 103 of the primary node 100P with the reception (D510).

The key management unit 201 of the key management server 200 backs up the encryption key table 304 (S507), and responds to the node controller 120 with an assignment result of the reserved encryption key (D511).

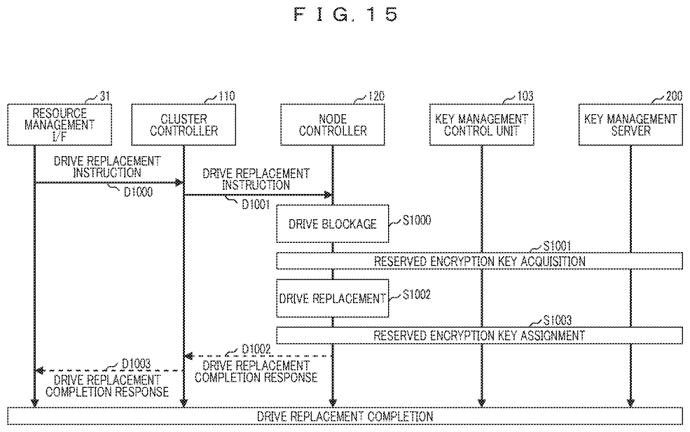

Next, processing of replacing the drive will be described by using FIG. 15.

The resource management I/F 31 of the controller node 30 instructs the cluster controller 110 of the primary node 100P to replace the drive (D1000).

The cluster controller 110 of the primary node 100P instructs the node controller 120 of the primary node 100P or the worker node 100W to replace the drive (D1001).

The node controller 120 blocks the drive (S1000). An operation for the maintenance personnel to replace the drive is included.

Next, processing of acquiring the reserved key is performed between the node controller 120 of the primary node 100P or the worker node 100W, the key management control unit 103 of the primary node 100P, and the key management server 200 (S1001, the details are illustrated in FIG. 13).

The node controller 120 replaces the drive (S1002). Note that, such processing may include processing for the maintenance personnel of the system to replace the drive.

Next, processing of assigning the reserved key is performed between the node controller 120 of the primary node 100P or the worker node 100W, the key management control unit 103 of the of the primary node 100P, and the key management server 200 (S1003, the details are illustrated in FIG. 14).

The node controller 120 responds to the cluster controller 110 with the completion of the replacement of the drive (D1002), and the cluster controller 110 responds to the resource management I/F 31 with the completion of the replacement of the drive (D1003).

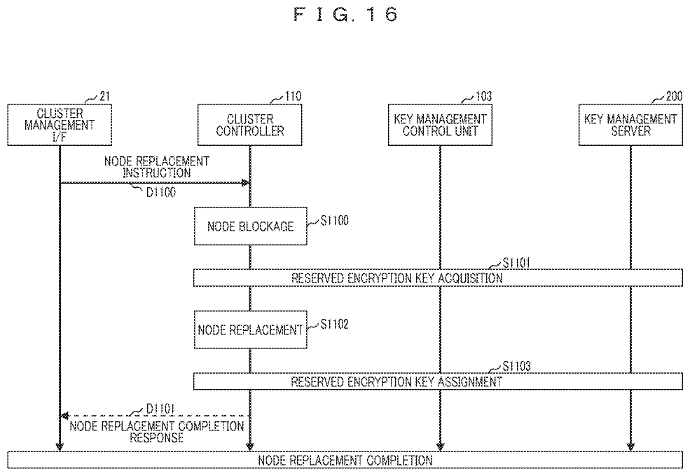

Next, processing of replacing the node will be described by using FIG. 16.

The cluster management I/F 21 of the maintenance node 20 instructs the cluster controller 110 of the primary node 100P to replace the node (D1100).

The cluster controller 110 of the primary node 100P blocks the node (S1100).

Next, the processing of acquiring the reserved key is performed between the cluster controller 110 of the primary node 100P, the key management control unit 103 of the primary node 100P, and the key management server 200 (S1101, the details are illustrated in FIG. 13).

The cluster controller 110 replaces the node (S1102). Note that, such processing may include processing for the maintenance personnel of the system to replace the node.

Next, the processing of assigning the reserved key is performed between the cluster controller 110 of the primary node 100P, the key management control unit 103 of the primary node 100P, and the key management server 200 (S1103, the details are illustrated in FIG. 14).

The cluster controller 110 responds to the cluster management I/F 21 with the completion of the replacement of the node (D1101).

According to this embodiment as described above, the reserved encryption key is managed by the database of the key management server 200 without being kept inside the storage. Accordingly, since the encryption key of the key management server 200 can be shared by the plurality of storages, the management burden of the security manager can be reduced, since there is no spare encryption key inside the storage, the security is ensured, and since the encryption key is not newly generated when replacing the drive during the maintenance, the maintenance time can also be shortened.

### Second Embodiment

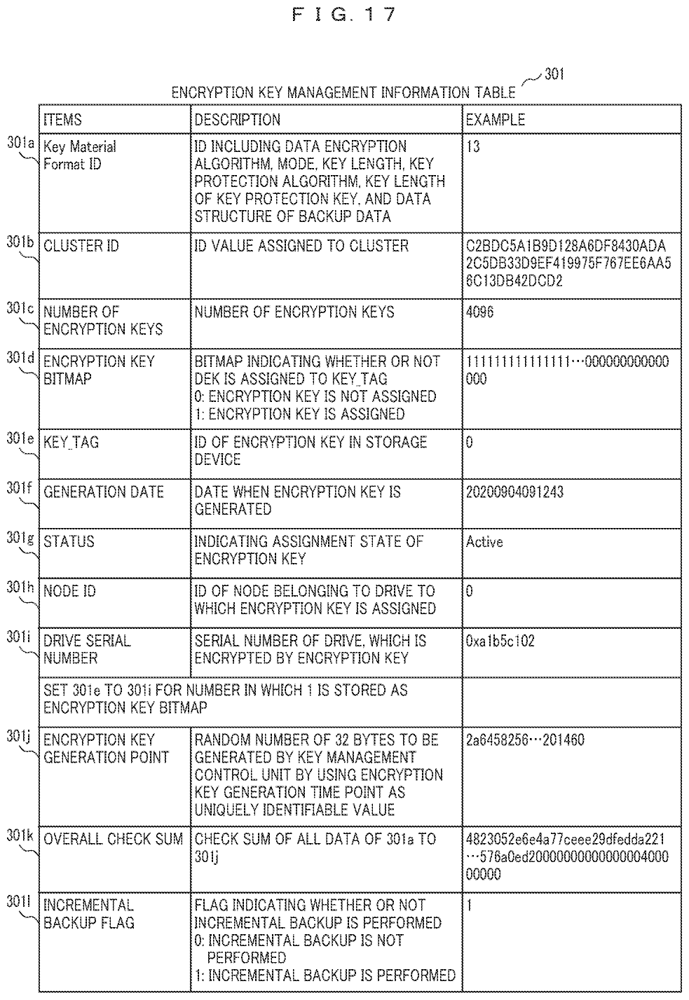

Hereinafter, a second embodiment according to the invention will be described by using FIG. 17 to FIG. 26.

In the first embodiment, an example has been described in which in the encryption key management system, the reserved encryption key is managed by the key management server, and acquired from the key management server when encrypting the data. After the encryption key is used, the information relevant to the encryption key is backed up in the key management server, which is premised on a full backup.

However, in the full backup, it takes time for the backup, which causes an increase in drive maintenance time and an increase in drive degeneration time. In general, since it takes time for the backup in accordance with the number of drives, the drive maintenance time or the drive degeneration time depends on the number of drives, which makes the scale-out of the drive difficult.

In this embodiment, in order to solve the problems described above, an incremental backup of the encryption key in the reserved encryption key area and the restoration thereof are performed.

Hereinafter, differences from the first embodiment will be mainly described.

The configuration of the encryption key management system of this embodiment is the same as the encryption key management system of the first embodiment illustrated in FIG. 1.

Next, a data structure of the second embodiment, which is special compared to the first embodiment, will be described by using FIG. 17 to FIG. 19.

The encryption key management information table 301 to be stored in the non-volatile area 140 of the primary node 100P of the second embodiment is approximately the same as that of the first embodiment, and as illustrated in FIG. 17, an incremental backup flag 301l is added. The incremental backup flag 301l is a flag indicating whether or not the incremental backup is performed, and the value indicates that “0: the incremental backup is not performed” and “1: the incremental backup is performed”.

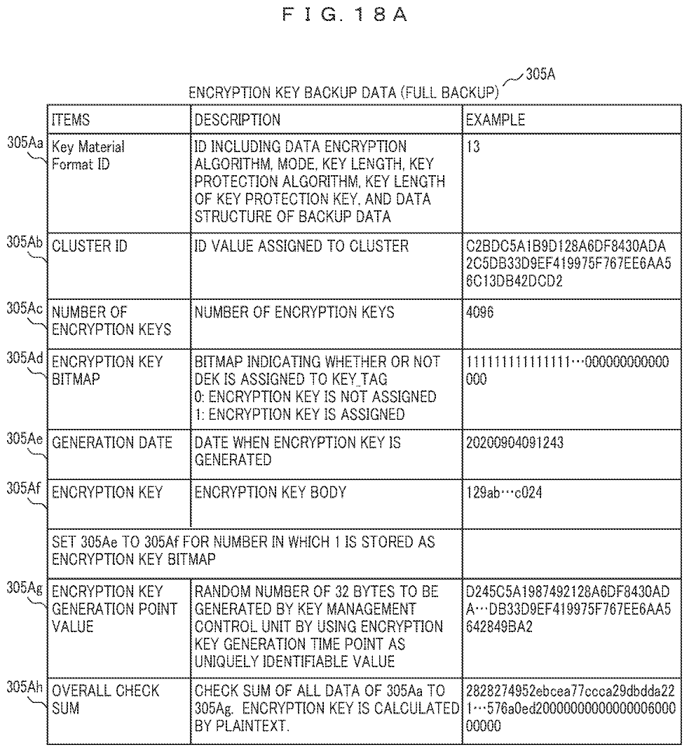

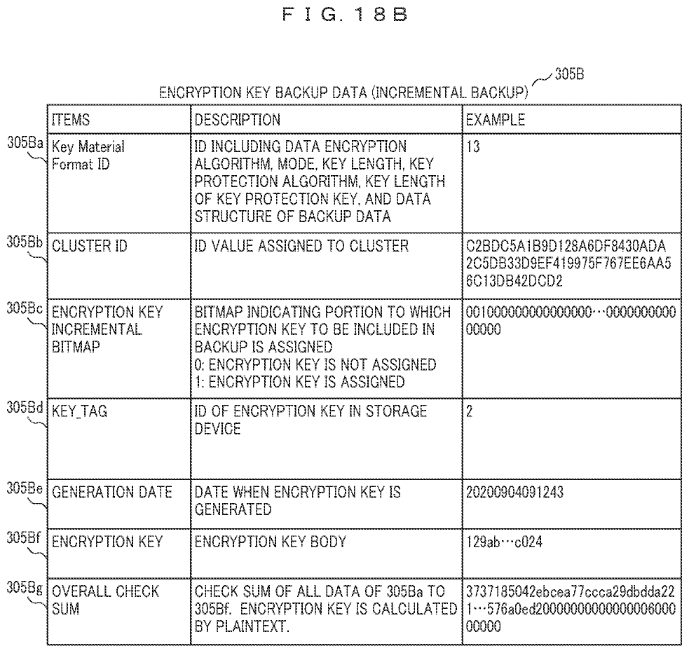

Encryption key backup data (full backup) 305A is data to be generated by backup data of the encryption key during the full backup, retained in the volatile area 130 of the primary node 100P of the cluster, and transmitted to the key management server 200. As illustrated in FIG. 18A, the encryption key backup data (full backup) 305A includes data items of a key material format ID 305Aa, a cluster ID 305Ab, a number 305Ac of encryption keys, an encryption key bitmap 305Ad, a generation date 305Ae, an encryption key 305Af, an encryption key generation point value 305Ag, and an overall check sum 305Ah.

The key material format ID 305Aa is an ID including a data encryption algorithm, a mode, a key length, a key protection algorithm, a key length of a key protection key, and a data structure of the backup data. The cluster ID 305Ab is an ID value assigned to the cluster. The number 305Ac of encryption keys is the number of encryption keys. The encryption key bitmap 305Ad is a bitmap indicating whether or not the encryption key is assigned to the KEY_TAG, and the value indicates that “0: the encryption key is not assigned” and “1: the encryption key is assigned”. The generation date 305Ae is a date when the encryption key is generated. The encryption key 305Af is an encryption key body. The encryption key generation point value 305Ag is a random number to be generated by the key management control unit by using the final encryption key generation time point as a uniquely identifiable value. The value is used for controlling the backup. The overall check sum 305A is the check sum of all the data of the key material format ID 305Aa, the cluster ID 305Ab, the number 305Ac of encryption keys, the encryption key bitmap 305Ad, the generation date 305Ae, the encryption key 305Af, and the encryption key generation point value 305Ag. Here, the encryption key is calculated by a plaintext.

Note that, the generation date 305Ae and the encryption key 305Af are retained for the number values of 1 stored in the encryption key bitmap 305Ad.

Encryption key backup data (incremental backup) 305B is data to be generated as backup data of the encryption key during the incremental backup, retained in the volatile area 130 of the primary node 100P of the cluster, and transmitted to the key management server 200. As illustrated in FIG. 18B, the encryption key backup data (incremental backup) 305B includes data items of a key material format ID 305Ba, a cluster ID 305Bb, an encryption key incremental bitmap 305Bc, a KEY_TAG 305Bd, a generation date 305Be, an encryption key 305Bf, and an overall check sum 305Bg.

The key material format ID 305Ba, the cluster ID 305Bb, the generation date 305Be, and the encryption key 305Bf are the same as the key material format ID 305Aa, the cluster ID 305Ab, the generation date 305Ae, and the encryption key 305Af of the encryption key backup data (full backup) 305A illustrated in FIG. 18A. The encryption key incremental bitmap 305Bc is a bitmap indicating a portion to which the encryption key to be included in the backup is assigned, and the value indicates that “0: the encryption key is not assigned” and “1: the encryption key is assigned”. The digit of the bitmap indicates a record position of the encryption key management information table. In a case where the digit of the bitmap is 1, it is indicated that the record in the encryption key management information table is valid.

The KEY_TAG 305d is the ID of the encryption key in the storage device. The overall check sum 305Bg is the check sum of all the data of the key material format ID 305Ba, the cluster ID 305Bb, the encryption key incremental bitmap 305Bc, the KEY_TAG 305d, the generation date 305Be, and the encryption key 305Bf. Here, the encryption key is calculated by the plaintext. The encryption key incremental bitmap 305Bc is prepared to update the bitmap corresponding to the encryption key management information table to 1 when restoring the incremental backup.

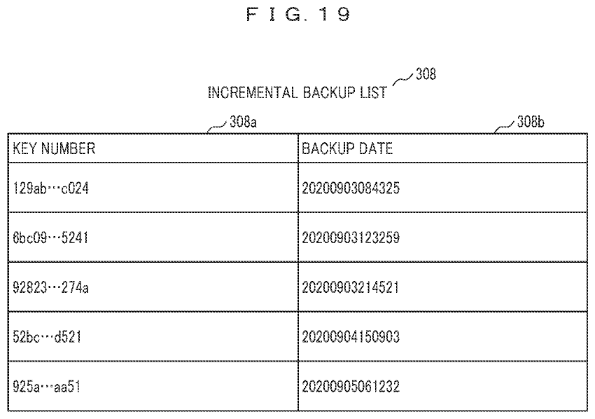

An incremental backup list 308 is a list for retaining information relevant to the incremental backup, and is retained in the primary node 100P of the cluster. As illustrated in FIG. 19, the incremental backup list 308 includes setting items of a key number 308a and backup date 308b.

The key number 308a is a key number of a key encryption key used when performing the incremental backup. The backup date 308b is data when performing the incremental backup.

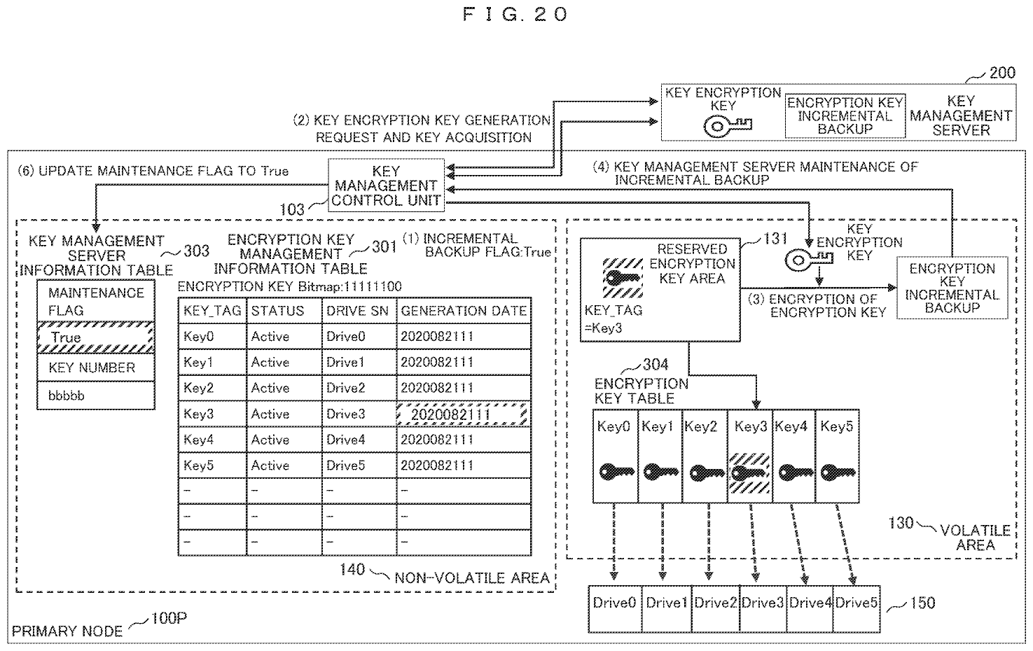

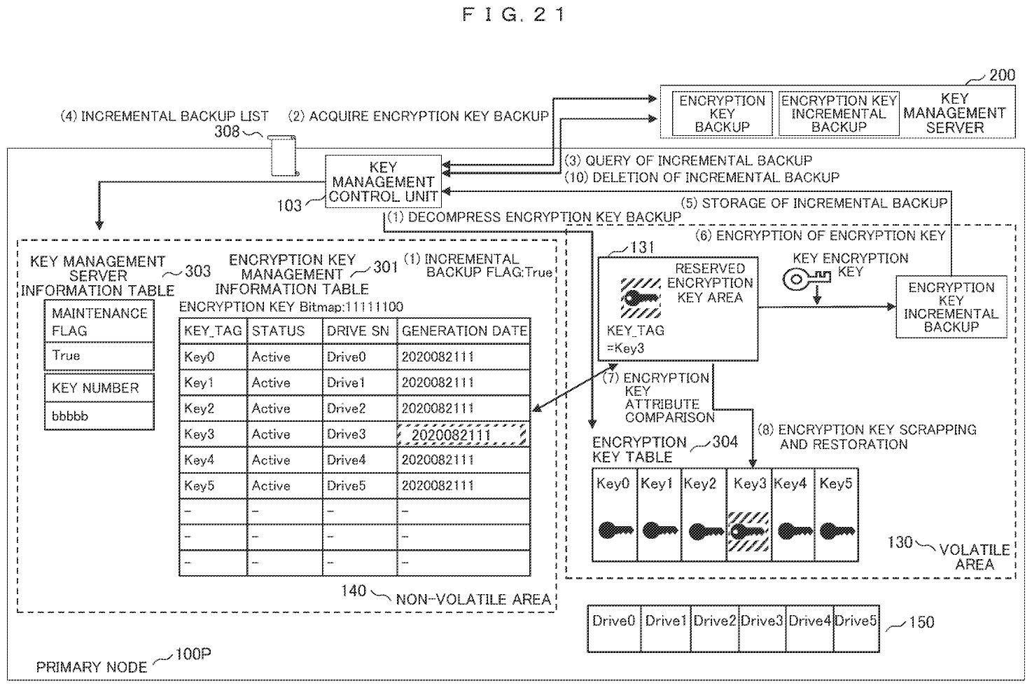

Next, the outline of an algorithm of the second embodiment will be described by using FIG. 20 and FIG. 21.

First, a set of processings until the primary node performs the incremental backup of the encryption key in the key management server will be described by using FIG. 20.

It is assumed that the KEY_TAG indicating a newly imported encryption key and a change portion exists in the reserved encryption key area 131 by the method of the first embodiment.

The incremental backup flag is newly created in the encryption key management information table 301. In a case where the incremental backup exists, the incremental backup flag is updated to True, and in a case where the full backup is performed, the incremental backup flag is updated to False.

In addition, in a case where an encryption key that is a backup target is used by the primary node in encryption processing, before the incremental backup is completed in the key management server, the encryption key may be lost from the volatile area, and thus, the maintenance flag is updated to False when executing backup processing.
(1) First, the incremental backup flag is updated to True.
   (2) The key management control unit 103 requests the key management server to generate the key encryption key, and acquires the key encryption key to be decompressed in the volatile area.
   (3) The encryption key of the reserved encryption key area 131, the encryption key attribute information, and the KEY_TAG information are collectively encrypted by the key encryption key, and the incremental backup of the encryption key is created.
   (4) The incremental backup of the encryption key is registered and maintained in the key management server. In this case, the following attribute values are applied to the backup.
      Object Group=“DEK_Incremental”
      Cluster ID (Storage Production Number in Case of Block Storage Product)
      Backup Date
      Key Number for Key Management Server to Uniquely Identify Key Encryption Key That Has Encrypted Incremental Backup
(5) The maintenance flag is updated to True.

Next, a set of processings until the primary node restores the incremental backup from the key management server will be described by using FIG. 21.
(1) The encryption key is decompressed in the volatile area 130 by encryption key restoration processing relevant to the existing encryption key.
(2) The incremental backup flag is checked, and in a case of True, the process proceeds to the subsequent processing. In a case of False, the process ends.
(3) The key management server 200 is queried about the attribute value and the key number of the incremental backup of the encryption key by using the following attribute as a query, and the incremental backup list 308 is created. In this case, all the key management servers 200 existing in the key management server information table 303 are queried.
   Object Group=“DEK_Incremental”
   Cluster ID (Storage Production Number in Case of Block Storage Product)
(4) The backup date of the incremental backup list is sorted in chronological order, and the key number of the oldest incremental backup is acquired.

Next, (5) to (8) described below are repeated for each element of the incremental backup list.
(5) The incremental backup of the encryption key is acquired by using the key number as a query, and stored in the volatile area 130. The key encryption key is also acquired from the key number attribute value of the key encryption key of the incremental backup of the encryption key, and stored in the volatile area 130.
(6) The incremental backup is decrypted by using the key encryption key, and the encryption key and the KEY_TAG are decompressed in the reserved encryption key area 131 of the volatile area 130.
(7) It is checked whether or not the generation dates are coincident with each other by comparing the KEY_TAG included in the incremental backup with the content of the encryption key management information table 301. In a case where the generation dates are coincident with each other, the encryption key is restored, and in a case where the generation dates are not coincident with each other, the encryption key is scrapped, and the process proceeds to the element of the next incremental backup.
(8) The encryption key that is stored in association with the KEY_TAG of the encryption key table is scrapped, and the encryption key of the reserved encryption key area 131 is stored.
(9) In a case where all the incremental backups are completed, the full backup of the encryption key is executed, and the incremental backup flag is updated to False.
(10) A list of the key numbers of the incremental backups is created by using the following queries, and a deletion request is performed for each list of the key numbers.
   Object Group=“DEK_Incremental”
   Cluster ID (Storage Production Number in Case of Block Storage Product)

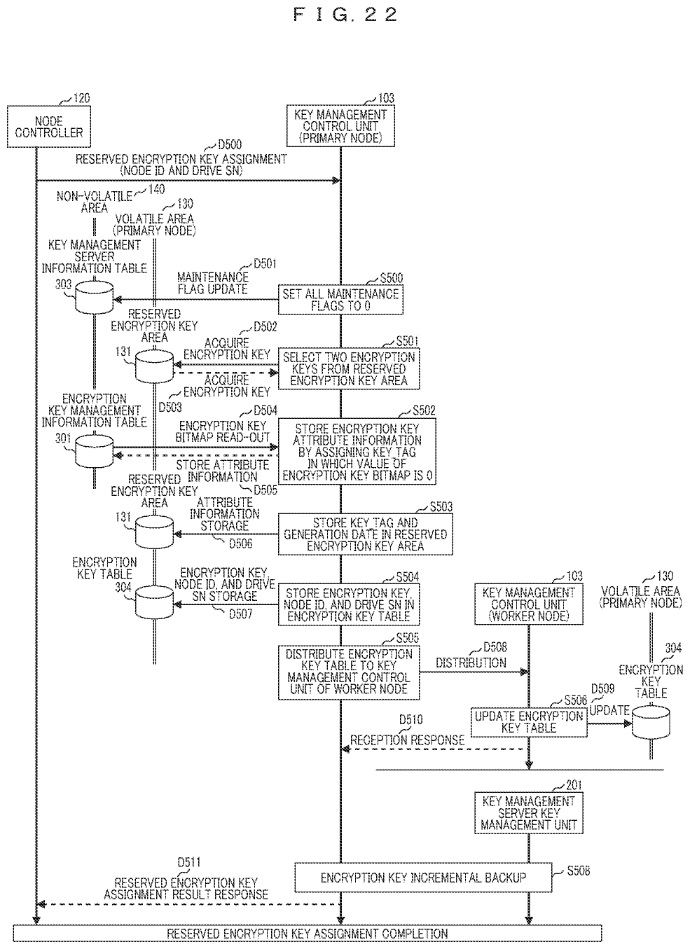

Next, the details of the processing of the encryption key management system of the second embodiment will be described by using FIG. 22 to FIG. 26.

First, the details of processing of assigning the reserved encryption key as the encryption key for encrypting the data will be described by using FIG. 22.

The processing of assigning the reserved encryption key as the encryption key for encrypting the data is different only in S507 of FIG. 14 of the first embodiment.

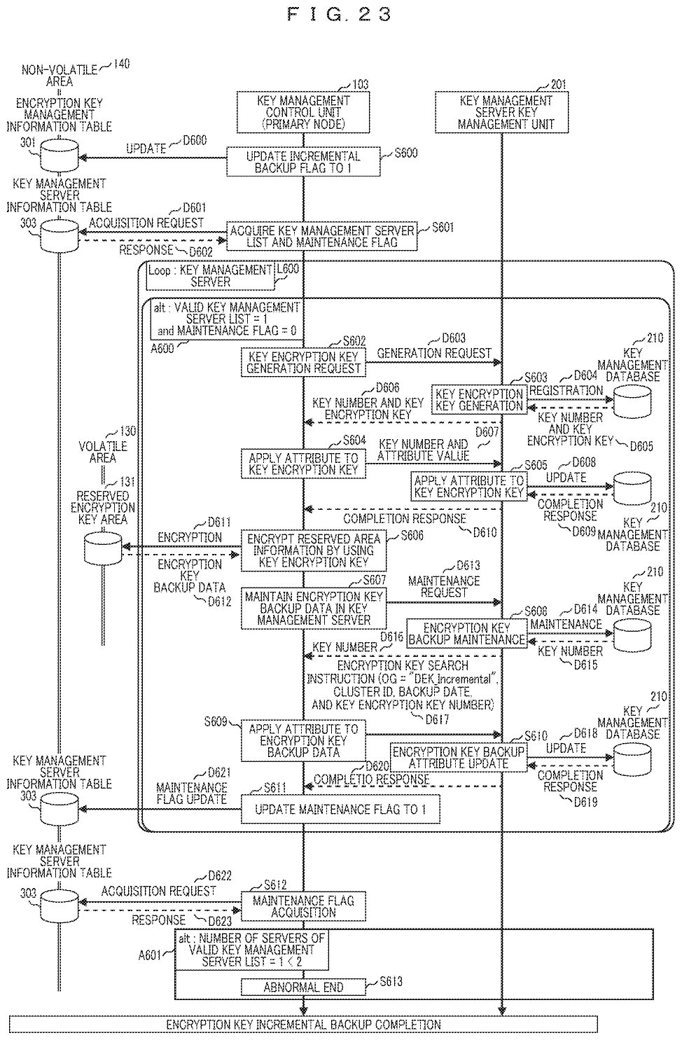

In this embodiment, instead of S507, the incremental backup of the encryption key is performed (S508, the details are illustrated in FIG. 23).

Next, the details of processing of performing the incremental backup of the encryption key will be described by using FIG. 23.

The key management control unit 103 of the primary node 100p updates the incremental backup flag of the encryption key management information table 301 to 1 (S600 and D600).

The key management control unit 103 acquires the valid key management server list and the maintenance flag of the key management server information table 303 (S601, D601, and D602).

When Valid Key Management Server List=1 and Corresponding Maintenance Flag=0 (A601), S602 to S611, the key management control unit 103 performs the loop processing of the processing of D603 to D621 (L600).

The key management control unit 103 requests the key management unit 201 to generate the key encryption key (S602 and D603).

The key management unit 201 generates the key encryption key (S603) to be registered in the key management database 210 (D604), and acquires the key number and the key encryption key (D605).

The key management unit 201 transmits the key number and the key encryption key to the key management control unit 103 (D606).

The key management control unit 103 applies the attribute to the key encryption key (S604), and transmits the key number and the attribute value to the key management control unit 103 (D607).

The key management unit 201 applies the attribute to the key encryption key (S605), updates the key management database 210 (D608), waits for a completion response (D609), and responds to the key management control unit 103 with the completion (D610).

The key management control unit 103 encrypts the reserved encryption key area information of the reserved encryption key area 131 by using the key encryption key (S606 and D611), and obtains the encryption key backup data (D612).

The key management control unit 103 requests the key management unit 201 to maintain the encryption key backup data (D613), thereby requesting the key management server 200 to maintain the encryption key backup data (S607).

The key management unit 201 maintains the encryption key backup data by registering the encryption key backup data in the key management database 210 (S608 and D614), and acquires the key number (D615).

The key management unit 201 transmits the key number to the key management control unit 103 (D616).

The key management control unit 103 instructs the key management unit 201 to designate OG=“DEK_Incremental”, the cluster ID, the backup date, the key number of the key encryption key and to apply the attribute to the encryption key backup data (S609 and D617).

The key management unit 201 updates the attribute in the encryption key backup data of the key management database 210 (S610 and D618), waits for a completion response (D619), and responds to the key management control unit 103 with the completion (D620).

The key management control unit 103 updates the maintenance flag of the key management server information table 303 to 1 (S611 and D621).

When the process exits from the loop of L600, the key management control unit 103 acquires the maintenance flag of the key management server information table 303 (S612 and D622), and waits for a response (S612).

When Number of Servers of Valid Key Management Server List=1<2 as a result of S612 (A601), the key management control unit 103 abnormally ends the process (S613).

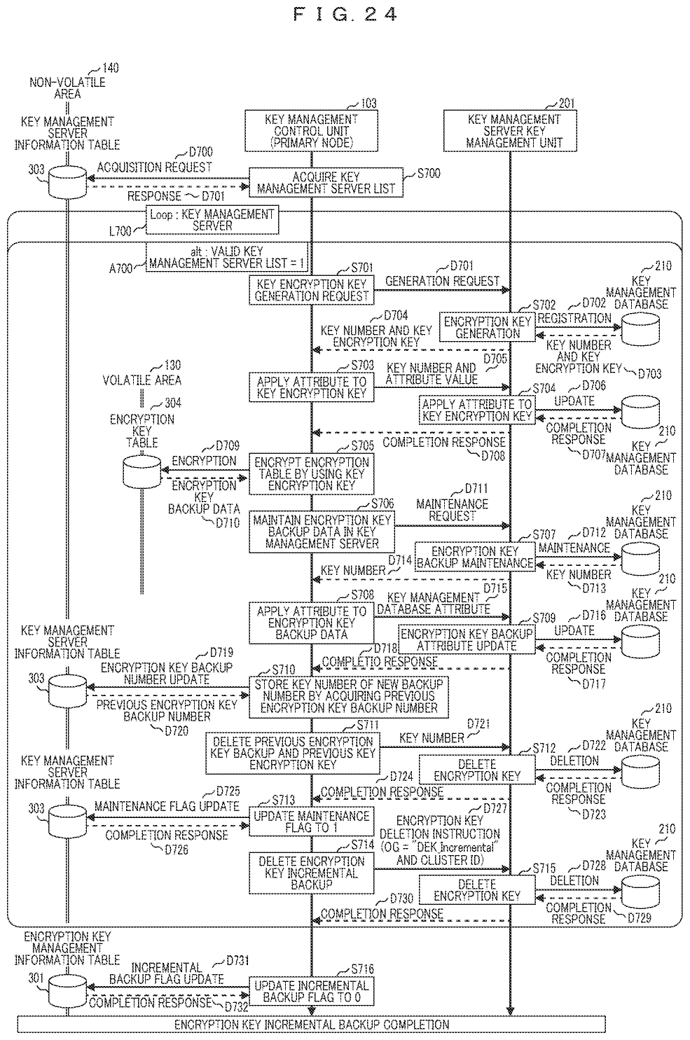

Next, the details of processing of performing the full backup of the encryption key will be described by using FIG. 24.

The key management control unit 103 acquires the valid key management server list of the key management server information table 303 (S700, D700, and D701).

When Valid Key Management Server List=1 (A700), for the key management server, the loop processing of the processing of S701 to S715, and D701 to D730 is performed (L700).

The key management control unit 103 requests the key management unit 201 to generate the key encryption key (S701 and D701).

The key management unit 201 generates the encryption key (S702) to be registered in the key management database 210 (D702), and acquires the key number and the key encryption key (D703).

The key management unit 201 transmits the key number and the key encryption key to the key management control unit 103 (D704).

The key management control unit 103 requests the key management control unit 103 to apply the attribute to the key encryption key (S703), and transmits the key number and the attribute value to the key management control unit 103 (D705).

The key management unit 201 applies the attribute to the key encryption key (S704), updates the key management database 210 (D706), waits for a completion response (D707), and responds to the key management control unit 103 with the completion (D708).

The key management control unit 103 encrypts the information of the encryption key table 304 by using the key encryption key (S705 and D709), and obtains the encryption key backup data (D710).

The key management control unit 103 requests the key management unit 201 to maintain the encryption key backup data (D711), thereby requesting the key management server 200 to maintain the encryption key backup data (S706).

The key management unit 201 maintains the encryption key backup data in the key management database 210 (S707 and D712), and acquires the key number (D713).

The key management unit 201 transmits the key number to the key management control unit 103 (D714).

The key management control unit 103 instructs the key management unit 201 to apply the attribute to the encryption key backup data (S708 and D715).

The key management unit 201 updates the attribute in the encryption key backup data of the key management database 210 (S709 and D716), waits for a completion response (D717), and notifies the key management control unit 103 of the completion response (D718).

The key management control unit 103 acquires the previous encryption key backup number from the key management server information table 303, and stores the key number of the new backup number (S710, D719, and D720).

The key management control unit 103 instructs the key management unit 201 to delete the previous encryption key backup and the previous key encryption key (S711 and D721).

The key management unit 201 deletes the instructed encryption key of the key management database 210 (S712 and D722), waits for a completion response (D723), and responds to the key management control unit 103 with the completion (D724).

The key management control unit 103 updates the maintenance flag of the key management server information table 303 to 1 (S713 and D725), and waits for a completion response (D726).

The key management control unit 103 requests the key management unit 201 to designate OG=“DEK_Incremental” and the cluster ID and to delete the encryption key incremental backup (S714 and D727).

The key management unit 201 deletes the instructed encryption key of the key management database 210 (S715 and D728), waits for a completion response (D729), and responds to the key management control unit 103 with the completion (D730).

In a case where the process exits from the loop L700, the incremental backup flag of the key management server information table 303 is updated to 0 (S716 and D731), the key management unit 201 waits for a completion response (D732).

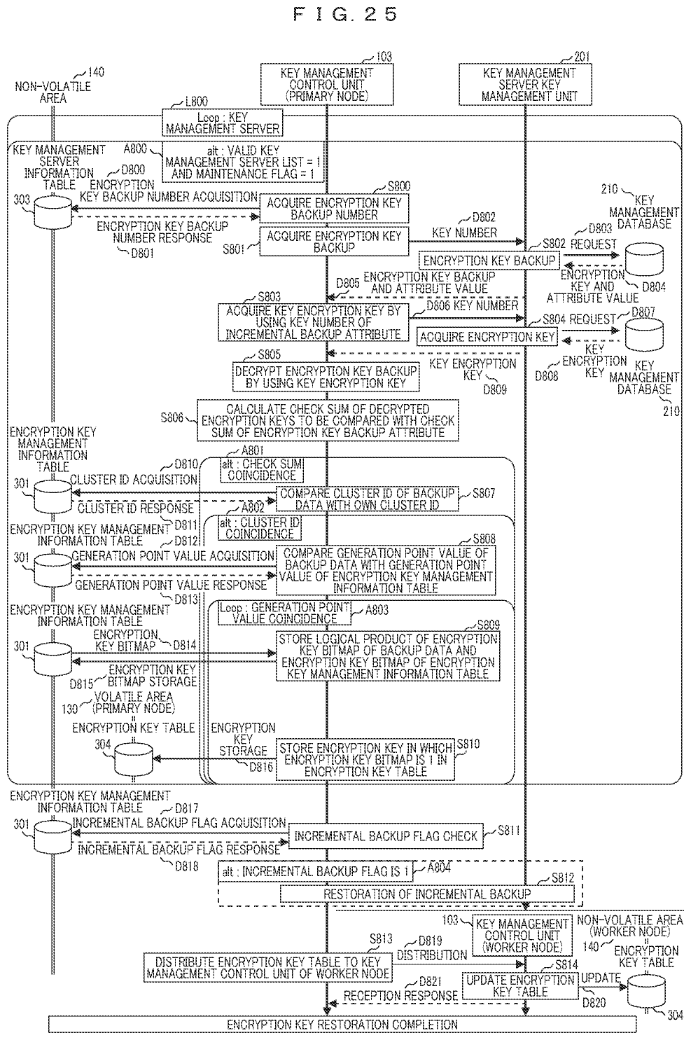

Next, the details of processing of restoring the encryption key will be described by using FIG. 25.

When Valid Key Management Server List=1 and Maintenance Flag=1 (A800), for the key management server, the loop of S800 to S810, and D800 to D816 is performed (L800).

The key management control unit 103 of the primary node 100p acquires encryption key backup number from the key management server information table 303 (S800, D800, and D801).

The key management control unit 103 requests the key management unit 201 to designate the encryption key backup number and to acquire the encryption key backup (S801 and D802).

The key management unit 201 requests the encryption key from the key management database 210 (S802 and D803), acquires the encryption key and the attribute value (D804), and transmits the encryption key backup and the attribute value to the key management control unit 103 (D805).

The key management control unit 103 designates the key number of the encryption key backup, and requests the key management unit 201 to acquire the key encryption key (S803 and D806).

The key management unit 201 requests the key encryption key from the key management database 210 (S804 and D807), acquires the key encryption key (D808), and transmits the key encryption key to the key management control unit 103 (D809).

The key management control unit 103 decrypts the encryption key backup by using the key encryption key (S805).

The key management control unit 103 calculates the check sum of the decrypted encryption keys, and compares the check sum with the check sum of the encryption key backup attribute (S806).

When the check sums are coincident with each other (A801), the key management control unit 103 acquires the cluster ID from the encryption key management information table 301 (D810 and D811), and compares the cluster ID of the backup data with the own cluster ID (S807).

When the cluster IDs are coincident with each other (A802), the key management control unit 103 acquires the generation point value of the encryption key management information table 301 (D812 and D813), and compares the generation point value of the backup data with the generation point value of the encryption key management information table 301 (S808).

When the generation point values are coincident with each other (A803), the key management control unit 103 acquires the encryption key bitmap from the encryption key management information table 301 (D814), takes a logical product of the encryption key bitmap of the backup data and the encryption key bitmap of the encryption key management information table, and stores the logical product in the encryption key management information table 301 (S809 and D815).

The key management control unit 103 stores the encryption key in which the encryption key bitmap is 1 in the encryption key table 304 (S810 and D816).

When the process exits from the loop L800, the key management control unit 103 acquires the incremental backup flag from the encryption key management information table 301 (D817 and D818), and checks the incremental backup flag (S811).

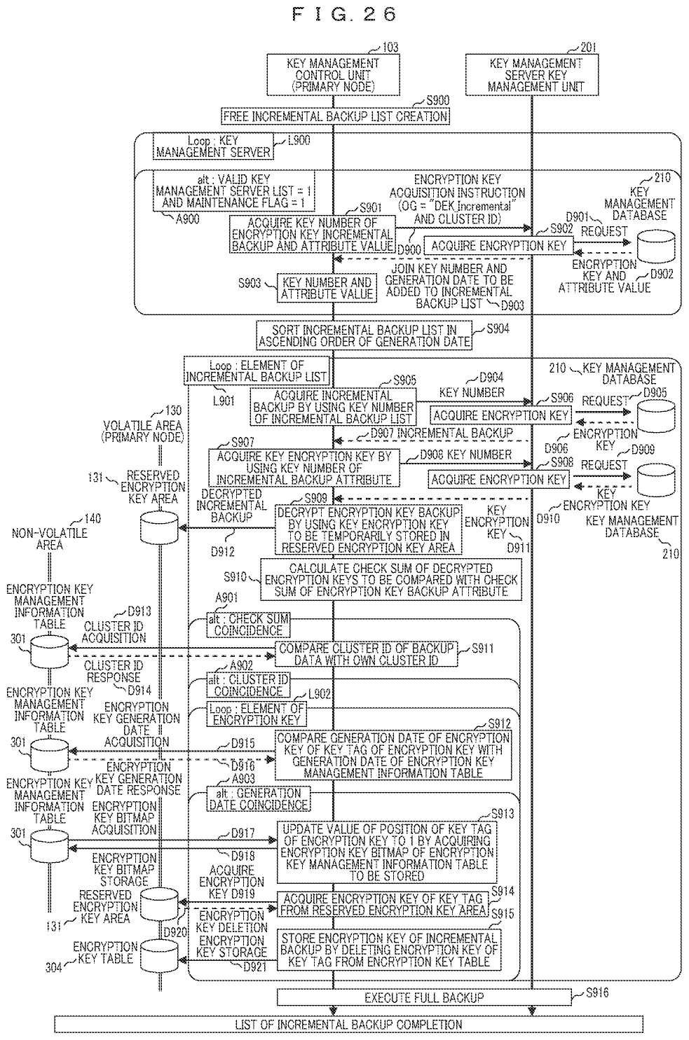

When the incremental backup flag is 1 (A804), the incremental backup is restored (S812, the details are illustrated in FIG. 26).

The key management control unit 103 of the primary node 100P distributes the information of the encryption key table 304 to the key management control unit 103 of the worker node 100W (S813 and D819).

The key management control unit 103 of the worker node 100W updates the encryption key table 304 (S814 and D820), and responds to the key management control unit 103 of the primary node 100P with the reception (D821).

Next, the details of processing of restoring the incremental backup will be described by using FIG. 26.

The key management control unit 103 of the primary node 100P creates the free incremental backup list 308 (S900).

When Valid Key Management Server List=1 and Maintenance Flag=1 (A900), for the key management server, the loop of S901 to S903, and D900 to D903 is performed (L900).

The key management control unit 103 requests the key management unit 201 to designate the OG=“DEK_Incremental” and the cluster ID and to acquire the encryption key of the encryption key backup number and the attribute value (S901 and D900).

The key management unit 201 requests the encryption key from the key management database 210 (S901 and D901), acquires the encryption key and the attribute value (D902), and transmits the encryption key backup and the attribute value to the key management control unit 103 (D903).

The key management control unit 103 joins the key number and the generation date to be added to the incremental backup list 308 (S903).

The key management control unit 103 sorts the incremental backup list 308 in ascending order of the generation date (S904).

Subsequently, for the element of the incremental backup list, the loop processing of the processing of S905 to S910, D905 to D912, and A901 is performed (L901).

The key management control unit 103 designates the key number of the incremental backup list 308, and instructs the key management unit 201 to acquire the incremental backup (D904).

The key management unit 201 acquires the encryption key from the key management database 210 (S906, D905, and D906), and transmits the incremental backup to the key management control unit 103 (D907).

The key management control unit 103 designates the key number of the incremental backup attribute, and instructs the key management unit 201 to acquire the key encryption key (S907 and D908).

The key management unit 201 acquires the key encryption key from the key management database 210 (S908, D909, and D910), and transmits the key encryption key to the key management control unit 103 (D911).

The key management control unit 103 decrypts the encryption key backup by using the key encryption key to be temporarily stored in the reserved encryption key area 131 (S909 and D912).

The key management control unit 103 calculates the check sum of the decrypted encryption keys, and compares the check sum with the check sum of the encryption key backup attribute (S910).

When the check sums are coincident with each other (A901), the processing of S911 and A902 is performed.

The key management control unit 103 acquires the cluster ID from the encryption key management information table 301 (D913 and D914), and compares the own cluster ID with the cluster ID of the backup data (S911).

When the cluster IDs are coincident with each other (A902), the key management control unit 103 acquires the generation date of the encryption key management information table 301 (D915 and D916), and compares the generation date of the encryption key of the KEY_TAG of the encryption key with the generation date of the encryption key table 304 (S912).

When the generation dates are coincident with each other (A903), the key management control unit 103 acquires the encryption key bitmap from the encryption key management information table 301 (D917), updates the value of the position of the KEY_TAG of the encryption key to 1, and stores the value (S913 and D918).

The key management control unit 103 acquires the encryption key of the KEY_TAG from the reserved encryption key area 131 (S914, D919, and D920).

The key management control unit 103 deletes the encryption key of the KEY_TAG of the encryption key table 304, and stores the encryption key of the incremental backup (S915 and D921).

In a case where the process exits from the loop processing of L901, the key management control unit 103 executes the full backup (S916, the details are illustrated in FIG. 24).

According to this embodiment as described above, it is possible to shorten the backup time and to avoid an increase in the drive maintenance time and an increase in the drive degeneration time by the incremental backup of the encryption key in the reserved encryption key area.

What is claimed is:

1. An encryption key management system comprising one or a plurality of drives assigned with different encryption keys, respectively, in which a storage device encrypting data by the assigned encryption key to store the data in the corresponding drive and a key management server storing the encryption key and information relevant to the encryption key in a key management database are connected to each other through a network,
wherein the storage device includes a key management control unit managing the encryption key, a volatile area for memorizing data, and a non-volatile area,
an encryption key table including the encryption key and information of the drive that is an assignment destination is retained in the volatile area,
an encryption key management information table including attribute information relevant to the encryption key and a key tag that is unique in the storage device and associated with the encryption key is retained in the non-volatile area,
the storage device performs reserved encryption key generation processing of instructing the key management server to generate the encryption key to be assigned to the drive,
the storage device performs reserved encryption key assignment processing of acquiring the encryption key generated in the reserved encryption key generation processing from the key management server and of assigning the encryption key to the drive,
in the reserved encryption key generation processing,
the key management control unit instructs the key management server to generate the encryption key, and
the key management server generates the instructed encryption key, and stores a key number that is unique in the key management server and associated with the encryption key in the key management database and transmits the key number to the storage device, and
in the reserved encryption key assignment processing,
the key management control unit requests the key management server to acquire the encryption key on the basis of the key number,
the key management server reads out an encryption key corresponding to the request for acquiring the encryption key and attribute information of the encryption key from the key management database, and transmits the encryption key and the attribute information to the key management control unit, and
the key management control unit stores the acquired encryption key as a reserved encryption key along with the attribute information in a reserved encryption key area of the volatile area, and
applies the key tag to the reserved encryption key to be stored and updated along with the attribute information in the encryption key management information table, and stores the reserved encryption key as a new encryption key corresponding to the drive that is an assignment target along with the key tag in the encryption key table.

2. The encryption key management system according to claim 1,
wherein in the reserved encryption key generation processing, the storage device requests the key management server to designate identification information of the storage device and to apply the identification information as the attribute information of the generated encryption key, and
the key management server stores the attribute information in the key management database in association with the encryption key on the basis of the request.

3. The encryption key management system according to claim 2,
wherein in the reserved encryption key assignment processing, the key management control unit further stores the key tag applied to the reserved encryption key in the reserved encryption key area,
the storage device performs incremental backup processing of generating a backup of the reserved encryption key and of registering the backup in the key management server, and
in the incremental backup processing,
the key management control unit instructs the key management server to generate a key encryption key,
the key management server generates the instructed key encryption key, and stores the key encryption key and a key number that is unique in the key management server and associated with the key encryption key in the key management database and transmits the key encryption key and the key number to the storage device,
the key management control unit stores the key encryption key in the volatile area, encrypts the encryption key, the attribute information of the encryption key, and the applied key tag, which are retained in the reserved encryption key area, by the key encryption key to create an incremental backup of the encryption key, and transmits the incremental backup to the key management server, and
the key management server registers and maintains the incremental backup along with the key number of the key encryption key and attribute information relevant to the incremental backup in the key management database.

4. The encryption key management system according to claim 3,
wherein the storage device performs restoration processing of reading out the incremental backup registered in the key management server and of assigning the encryption key to be included in the incremental backup to the corresponding drive, and
in the restoration processing,
the key management control unit requests the key management server to acquire the attribute information of the corresponding incremental backup and the key number of the key encryption key on the basis of the identification information of the own storage device,
further requests the key management server to acquire the corresponding incremental backup and the key encryption key on the basis of the acquired key number of the key encryption key,
stores the acquired incremental backup and the key encryption key in the volatile area, decrypts the incremental backup by the key encryption key, and decompresses the obtained encryption key, the attribute information of the encryption key, and the applied key tag in the volatile area, and
searches the encryption key management information table by using the applied key tag, compares the attribute information of the encryption key to be retained corresponding to the key tag with the attribute information of the decompressed encryption key, and stores the encryption key as a new encryption key corresponding to the drive along with the key tag in the encryption key table in a case where the attribute information items are coincident with each other.

5. The encryption key management system according to claim 1,
wherein one or a plurality of worker storage devices are respectively connected to the storage device through a network,
each of the worker storage devices
includes one or a plurality of drives assigned with different encryption keys, respectively, encrypts data by the assigned encryption key, and stores the data in the corresponding drive, and
includes a key management control unit managing the encryption key, and a volatile area for memorizing data,
an encryption key table including the encryption key and information of the drive that is an assignment destination is retained in the volatile area,
the encryption key table of the storage device includes the encryption key and the information of the drive of each of the worker storage devices as the assignment destination,
the key management control unit of the storage device distributes the encryption key table to each of the worker storage devices after the reserved encryption key assignment processing or the restoration processing of the incremental backup is completed, and
the key management control unit of each of the worker storage devices stores and updates the distributed encryption key table in the volatile area.

6. An encryption key management method of an encryption key management system comprising one or a plurality of drives assigned with different encryption keys, respectively, in which a storage device encrypting data by the assigned encryption key to store the data in the corresponding drive and a key management server storing information relevant to the encryption key in a key management database are connected to each other through a network,
wherein the storage device includes a key management control unit managing the encryption key, a volatile area for memorizing data, and a non-volatile area,
an encryption key table including the encryption key and information of the drive that is an assignment destination is retained in the volatile area,
an encryption key management information table including attribute information relevant to the encryption key and a key tag that is unique in the storage device and associated with the encryption key is retained in the non-volatile area,
the storage device performs reserved encryption key generation processing of instructing the key management server to generate the encryption key to be assigned to the drive,
the storage device performs reserved encryption key assignment processing of acquiring the encryption key generated in the reserved encryption key generation processing from the key management server and of assigning the encryption key to the drive,
the reserved encryption key generation processing includes:
a step for the key management control unit to instruct the key management server to generate the encryption key; and
a step for the key management server to generate the instructed encryption key, and to store a key number that is unique in the key management server and associated with the encryption key in the key management database and to transmit the key number to the storage device, and
the reserved encryption key assignment processing includes:
a step for the key management control unit to request the key management server to acquire the encryption key on the basis of the key number;
a step for the key management server to read out an encryption key corresponding to the request for acquiring the encryption key and attribute information of the encryption key from the key management database, and to transmit the encryption key and the attribute information to the key management control unit;
a step for the key management control unit to store the acquired encryption key as a reserved encryption key along with the attribute information in a reserved encryption key area of the volatile area;
a step for the key management control unit to apply the key tag to the reserved encryption key to be stored and updated along with the attribute information in the encryption key management information table; and
a step for the key management control unit to store the reserved encryption key as a new encryption key corresponding to the drive that is an assignment target along with the key tag in the encryption key table.
